(19) United States
(12) Patent Application Publication
(10) Pub. No.: US 2026/0286602 A1
(43) Pub. Date: Sep. 24, 2026

(54) INK JET TEXTILE PRINTING INK AND INK JET RECORDING METHOD

(71) Applicant: DIC Corporation, Tokyo (JP)

(72) Inventors: Maiko Kitade, Kitaadachi-gun (JP); Jumpei Kondo, Kitaadachi-gun (JP)

(73) Assignee: DIC Corporation, Tokyo (JP)

(21) Appl. No.: 19/490,093

(22) PCT Filed: Jun. 6, 2024
(86) PCT No.: PCT/JP2024/020622

§ 371 Date: Dec. 4, 2025

(30) Foreign Application Priority Data
Jun. 22, 2023 (JP) 2023-102425

(51) Int. Cl. D06P 1/52; D06P 1/651; D06P 5/30

(52) U.S. Cl. CPC D06P 1/5285; D06P 1/5221; D06P 1/65118; D06P 5/30

(57) ABSTRACT

An object of the present invention is to provide an ink jet textile printing ink that does not cause image cracking when printed matter is stretched, and does not block a path even when the ink is circulated by a circulation type ink jet head. The present invention achieves the above object by an ink jet textile printing ink containing a pigment and a binder resin, the binder resin containing a polyether-based urethane resin, and a difference between an indentation depth at 100° C. and an indentation depth at 30° C. of a 15 μm thick coating film of the ink applied onto a polyethylene terephthalate plate and dried being less than 250 nm.

### TECHNICAL FIELD

The present invention relates to an ink jet textile printing ink and an ink jet recording method.

### BACKGROUND ART

Screen printing has been the mainstream for conventional textile printing method for fabrics, but textile printing by ink jet printing using aqueous pigment inks is emerging in accordance with the needs of environmental load reduction and small-lot, multi-variety printing. If the aqueous pigment ink has poor fixability and followability on fabrics, the ink will not follow the fabric when the resulting textile printed matter is stretched, causing cracking in printed images, and aqueous pigment inks having good fixability and followability are being developed.

For dark-colored fabrics, a method is performed in which a white ink containing a white pigment is formed as a base layer, and a color ink is printed on top of it to make the image easier to recognize. However, a problem arises in which if the color development of the white ink, that is, whiteness, is low, the color development of the color ink also decreases. If coating film physical properties, such as strength and elongation, of the white ink are poor, the textile printed matter obtained by printing the color ink on the white ink will also crack, resulting in poor quality.

In recent years, as an ink jet printing apparatus, a printing apparatus including an ink circulation type ink jet head is known in order to prevent clogging or the like of ejection nozzles due to sedimentation of pigments, resin particles, and the like in the ink jet head.

While the ink circulation type ink jet head is increasingly being used for the color ink, especially in the case of the white ink, which often mainly contains titanium oxide as the pigment, the ink in a path is required to be circulated in order to inhibit sedimentation. Therefore, in the case of the white ink in particular, especially suitability for the ink circulation type ink jet head is important.

One of the textile printing methods using ink jet printing is direct-to-garment (DTG) printing, in which printing is done directly on the fabric. However, this printing method has the disadvantage that it is difficult to obtain high color development, and there is a need to apply a pretreatment agent or increase the amount of the ink applied for image formation with high color development, which impairs the texture of the fabric.

In contrast, as a more convenient method to obtain high color development, direct-to-film (DTF) printing, a method in which an image once formed on a film using a transfer film is formed on the fabric through thermal transfer, is attracting attention.

For example, PTL 1 discloses a technology in which a transfer film with a specific ink is produced, and then heat-transferred onto a pre-treated fabric, and further fixability is improved by posttreatment.

However, the technology described in PTL 1 pays no attention to the strength of an ink coating film after printing or suitability for circulation, and may cause defects such as cracking when a fabric printed matter is stretched or block the path by circulation.

### CITATION LIST

### Patent Literature

PTL 1: Japanese Unexamined Patent Application Publication No. 2022-21342

### SUMMARY OF INVENTION

### Technical Problem

In view of the above, an object of the present invention is to provide an ink jet textile printing ink that does not cause image cracking when printed matter is stretched, and does not block a path even when the ink is circulated by a circulation type ink jet head.

### Solution to Problem

The present invention achieves the above object by an ink jet textile printing ink containing a pigment and a binder resin, the binder resin containing a polyether-based urethane resin, and a difference between an indentation depth at 100° C. and an indentation depth at 30° C. of a 15 μm thick coating film of the ink applied onto a polyethylene terephthalate plate and dried being less than 250 nm.

An example of the configuration of the present invention that achieves the above object is as follows.

Item 1. An ink jet textile printing ink containing:
a pigment; and
a binder resin
the binder resin containing a polyether-based urethane resin, and
a difference between an indentation depth at 100° C. and an indentation depth at 30° C. of a 15 μm thick coating film of the ink applied onto a polyethylene terephthalate plate and dried being less than 250 nm.

Item 2. The ink jet textile printing ink according to Item 1, in which the pigment is a white pigment.

Item 3. The ink jet textile printing ink according to Item 2, in which the white pigment is alumina-treated titanium oxide.

Item 4. A method for producing printed matter, the method including:
a step of printing the ink jet textile printing ink according to any one of Items 1 to 3 onto a film base material to obtain a transfer film; and
a step of overlapping a transferred surface of a fabric and a printed surface of the transfer film, and performing thermal transfer.

Item 5. The method for producing printed matter according to Item 4, further including a step of applying an adhesive resin to the printed surface of the transfer film.

Item 6. Textile printed matter in which an ink jet textile printing ink containing a pigment and a binder resin is printed on a fabric,
the binder resin being a polyether-based urethane resin, and
the ink being an ink having a difference between an indentation depth at 100° C. and an indentation depth at 30° C. of a 15 μm thick coating film of the ink applied onto a polyethylene terephthalate plate and dried of less than 250 nm.

### Advantageous Effects of Invention

The present invention can provide an ink jet textile printing ink that provides high color density in printed matter, does not cause image cracking during stretching, and does not block a path even when the ink is circulated.

The present invention can also provide an ink jet textile printing white ink that provides high whiteness in printed matter, does not cause image cracking during stretching, and does not block the path even when the ink is circulated.

### BRIEF DESCRIPTION OF DRAWING

FIG. 1 is a schematic diagram of a microreactor for use in the present invention.

### DESCRIPTION OF EMBODIMENTS

The ink jet textile printing ink of the present invention is an ink jet textile printing ink containing a pigment and a binder resin, the binder resin containing a polyether-based urethane resin, and a difference between an indentation depth at 100° C. and an indentation depth at 30° C. of a 15 μm thick coating film of the ink applied onto a polyethylene terephthalate plate and dried being less than 250 nm.

### (Binder Resin)

The binder resin for use in the ink jet textile printing ink of the present invention is a polyether-based urethane resin.

### (Polyether-Based Urethane Resin)

The polyether-based urethane resin refers to a polyurethane resin containing a polyether diol as a polymer polyol component (a soft segment). The content of the polyether diol contained in a diol used as a raw material of the polyether-based urethane resin is preferably in a range of 10% by mass to 90% by mass. It is more preferable to use one in a range of 50% by mass to 90% by mass in order to inhibit clogging over time of a filter provided in the middle of an ink circulation path. The polyether-based urethane resin may also contain a polycarbonate diol, a polyester diol, or the like in the raw material as needed, and from the viewpoint of performance balance, only the polyether diol is preferably contained.

As the polyether-based urethane resin, it is preferable to use a polyurethane having a hydrophilic group in order to improve water dispersion stability in the ink jet textile printing ink of the present invention.

As the hydrophilic group, those generally referred to as an anionic group, a cationic group, and a nonionic group can be used. Among them, an anionic group or cationic group is preferably used as the hydrophilic group.

As the anionic group, for example, a carboxy group, a carboxylate group, a sulfonic acid group, a sulfonate group, and the like can be used, and among them it is preferable to use carboxylate groups or sulfonate groups that are partially or fully neutralized by a basic compound or the like in order to maintain good water dispersion stability.

Examples of the basic compound that can be used to neutralize the carboxy group or sulfonic acid group as the anionic group include organic amines such as ammonia, triethylamine, pyridine, and morpholine, alkanolamines such as monoethanolamine, and metal base compounds containing Na, K, Li, Ca, or the like. Among them, as the basic compound, it is preferable to use organic amines, and it is more preferable to use organic amines such as ammonia and triethylamine with a boiling point of 100° C. or lower in order to prevent a problem with the washing fastness of a printed image due to remaining in the printed image (that is, a dry coating film) formed by the ink jet textile printing ink of the present invention from occurring.

As the cationic group, for example, tertiary amino groups and the like can be used. As an acidic compound that can be used to neutralize some or all of the tertiary amino groups, for example, formic acid, acetic acid, and the like can be used. As a quaternizing agent that can be used to quaternize some or all of the tertiary amino groups, for example, dialkyl sulfates such as dimethyl sulfate and diethyl sulfate can be used.

As the nonionic group, for example, polyoxyalkylene groups such as a polyoxyethylene group, a polyoxypropylene group, a polyoxybutylene group, a poly(oxyethylene-oxypropylene) group, and a polyoxyethylene-polyoxypropylene group can be used. Among them, as the nonionic group, it is preferable to use a polyoxyalkylene group having an oxyethylene unit in order to further improve hydrophilicity.

As the polyether-based urethane resin, it is preferable to use one having the hydrophilic group in an amount of 0.5% by mass to 30% by mass with respect to the total amount of the polyether-based urethane resin, and in order to obtain an ink having even better water dispersion stability, it is more preferable to use one having the hydrophilic group in an amount of 1% by mass to 20% by mass.

As the polyether-based urethane resin, a reaction product of a polyol containing a polyether polyol and a polyol having a hydrophilic group, and a polyisocyanate can be used.

Examples of the polyether polyol include ones obtained by addition polymerizing a cyclic ether compound such as ethylene oxide, propylene oxide, butylene oxide, styrene oxide, epichlorohydrin, or tetrahydrofuran with a compound having two or more active hydrogen groups such as ethylene glycol, diethylene glycol, triethylene glycol, propylene glycol, trimethylene glycol, 1,3-butanediol, 1,4-butanediol, 1,6-hexanediol, neopentyl glycol, glycerin, trimethylolethane, trimethylolpropane, sorbitol, sucrose, aconitic sugar, hemimellitic acid, phosphoric acid, ethylenediamine, diethylenetriamine, triisopropanolamine, pyrogallol, dihydroxybenzoic acid, hydroxyphthalic acid, and 1,2,3-propane trithiol, and ones obtained by ring-opening polymerizing the cyclic ether compound with a cationic catalyst, a protic acid, a Lewis acid, or the like as a catalyst.

As the polyether polyol, it is preferable to use polyether polyols such as poly tetramethylene ether glycol with a number average molecular weight of 500 to 4,000, it is more preferable to use polyether polyols such as poly tetramethylene ether glycol with a number average molecular weight of 1,000 to 4,000, and it is even more preferable to use poly tetramethylene ether glycol with a number average molecular weight of 2,000 to 4,000.

As the polyol having a hydrophilic group, for example, polyols having a cationic group such as polyols having a tertiary amino group can be used. As the polyol having a tertiary amino group, specifically, polyols obtained by reacting N-methyl-diethanolamine, a compound having two epoxies, and a secondary amine and the like can be used.

As the polyol having a hydrophilic group, ones having an anionic group can be used, and, for example, 1,2-bis(hydroxymethyl)propionic acid, 1,2-bis(hydroxymethyl)butanoic acid, and the like can be used.

As the polyol having a hydrophilic group, ones having a nonionic group can be used, and, for example, polyethylene glycol, polypropylene glycol, and the like having an ethylene oxide-derived structural unit can be used.

As the polyol that can be used for the production of the polyether-based urethane resin, other polyols can be used as needed in addition to those described above.

Examples of the polyisocyanate that reacts with the polyol containing the polyether polyol include aromatic diisocyanates such as phenylene diisocyanate, tolylene diisocyanate, diphenylmethane diisocyanate, and naphthalene diisocyanate; and aliphatic or alicyclic structure-containing diisocyanates such as hexamethylene diisocyanate, lysine diisocyanate, cyclohexane diisocyanate, isophorone diisocyanate, dicyclohexylmethane diisocyanate, xylylene diisocyanate, and tetramethylxylylene diisocyanate, which can be used alone or two or more of which can be used in combination.

Among them, when the ink jet textile printing ink of the present invention is used for printing on fabrics such as clothing, as the polyisocyanate, it is preferable to use aliphatic or alicyclic structure-containing diisocyanates such as isophorone diisocyanate and dicyclohexylmethane diisocyanate in order to further improve the texture of printed matter, and it is preferable to use especially dicyclohexylmethane diisocyanate because it inhibits elongation cracking during coating film stretching and also suitably acts on circulation filtration properties.

When a chain extender is used when the polyether-based urethane resin is produced, examples thereof include polyamine-based chain extenders such as diamines such as ethylenediamine, 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, and 1,4-cyclohexanediamine; N-hydroxymethylaminoethylamine, N-hydroxyethylaminoethylamine, N-hydroxypropylaminopropylamine, N-ethylaminoethylamine, and N-methylaminopropylamine; diethylenetriamine, dipropylenetriamine, and triethylenetetramine; hydrazine, N,N′-dimethylhydrazine, and 1,6-hexamethylenebishydrazine; succinic acid dihydrazide, adipic acid dihydrazide, glutaric acid dihydrazide, sebacic acid dihydrazide, and isophthalic acid dihydrazide; and β-semicarbazide propionic acid hydrazide, 3-semicarbazide-propyl-carbazate, and semicarbazide-3-semicarbazidomethyl-3,5,5-trimethylcyclohexane. It is preferable to use hydrazine or isophoronediamine in order to obtain an ink that is unlikely to cause clogging during circulation and can produce printed matter having excellent washing fastness. In addition to polyamines, glycols such as ethylene glycol, diethylene glycol, triethylene glycol, propylene glycol, 1,3-propanediol, 1,3-butanediol, 1,4-butanediol, hexamethylene glycol, neopentyl glycol, saccharose, methylene glycol, glycerin, and sorbitol; phenols such as bisphenol A, 4,4′-dihydroxy diphenyl, 4,4′-dihydroxy diphenyl ether, 4,4′-dihydroxy diphenyl sulfone, hydrogenated bisphenol A, and hydroquinone; water; and the like can be used.

The chain extender can be used during the reaction of the polyol and the polyisocyanate or after the reaction.

It is preferable to use the polyether-based urethane resin in a range of 1% by mass to 22% by mass with respect to the total amount of the ink jet textile printing ink of the present invention, and in order to inhibit clogging over time of the filter provided in the middle of the ink circulation path, it is more preferable to use it in a range of 8% by mass to 15% by mass.

The polyether-based urethane resin has a viscosity as an aqueous dispersion with a nonvolatile content of 20% of preferably 300 mPa-s or less, more preferably 200 mPa-s or less, and even more preferably 100 mPa-s or less. When the viscosity is within this range, it is easier to adjust the viscosity of the ink, and the degree of freedom in ink blending improves.

The polyether-based urethane resin has a glass transition temperature (Tg) of preferably 0° C. or lower, more preferably −20° C. or lower, even more preferably −40° C. or lower, and particularly preferably −50° C. or lower. When the glass transition temperature is within this range, when made into a coating film on the fabric, the coating film easily follows the stretching of the fabric.

More specifically, the glass transition temperature is preferably −95 to −60° C., and preferably −90 to −70° C.

Note that the glass transition temperature is obtained by measurement conforming to JIS K 7121 using a differential scanning calorimeter (DSC).

The polyether-based urethane resin has a flow starting temperature of preferably 150° C. or higher, more preferably 160° C. or higher, even more preferably 170° C. or higher, and particularly preferably 180° C. or higher. When the flow starting temperature is within this range, the coating film is less likely to crack because it is less likely to flow when heated on the fabric.

One method of adjusting the flow starting temperature to a higher temperature is, for example, to use a polyisocyanate with high crystallinity, such as dicyclohexylmethane diisocyanate.

More specifically, the flow starting temperature is preferably 170 to 195° C., and more preferably 175 to 190° C.

The flow starting temperature can be measured on dry matter of resin using a flow tester manufactured by Shimadzu Corporation “CFT-500A” (using a die 1 MM in diameter and 1 MM in length, load: 98 N, temperature rise rate: 3° C./min).

The polyether-based urethane resin has an acid value of preferably 5 to 40 mgKOH/g, more preferably 8 to 30 mgKOH/g, even more preferably 10 to 24 mgKOH/g, and particularly preferably 10 to 20 mgKOH/g. When the acid value is within this range, the dispersion stability of the ink is good, and it is easier to inhibit clogging over time of the filter provided in the middle of the ink circulation path.

As the polyether-based urethane resin, it is preferable to use one with a weight average molecular weight in a range of 10,000 to 400,000, and in order to inhibit clogging over time of the filter provided in the middle of the ink circulation path, it is more preferable to use one with a weight average molecular weight in a range of 40,000 to 300,000.

The polyether-based urethane resin is dispersed as particles in an aqueous medium, and its particle size is preferably 70 μm or more, and more preferably 75 μm or more, which is not limiting. Note that the particle size of the polyether-based urethane resin is the value of a cumulative frequency 50% diameter (D50) measured by dynamic light scattering.

The ink jet textile printing ink of the present invention can contain a cross-linking agent described below for the purpose of further improving abrasion resistance such as washing fastness. When the cross-linking agent is used, as the polyether-based urethane resin, it is preferable to use one having a functional group that can cross-link with a functional group of the cross-linking agent.

However, since it cannot be denied that the ink containing the cross-linking agent may cross-link in the circulation path of the ink circulation type ink jet head, the ink preferably does not contain the cross-linking agent in order to prevent clogging or the like of the filter provided in the circulation path.

### (Other Binder Resins)

The ink jet textile printing ink of the present invention may contain other binder resins other than the polyether-based urethane resin to the extent that the effect of the present invention is not impaired.

Examples of such other binder resins include polyurethane resins such as a polycarbonate-based urethane resin and a polyester-based urethane resins, acrylic resins, and olefin resins.

As the polycarbonate-based urethane resin, a reaction product of a polyol containing a polycarbonate polyol and a polyisocyanate can be used. As the polycarbonate-based urethane resin, a reaction product of a polyol containing a polycarbonate polyol and a polyol having a hydrophilic group and a polyisocyanate can be used. When a polyurethane having urea bonds is used as the polycarbonate-based urethane resin, a reaction product of a reaction product of a polyol containing a polycarbonate polyol and a polyisocyanate and a chain extender such as a polyamine can be used.

As the polycarbonate polyol, for example, a reaction product of a carbonate and a low molecular weight polyol, preferably a linear aliphatic diol can be used.

As the carbonate, methyl carbonate, dimethyl carbonate, ethyl carbonate, diethyl carbonate, cyclocarbonate, diphenyl carbonate, and the like can be used.

Examples of the low molecular weight polyol that can react with the carbonate include dihydroxy compounds with a relatively low molecular weight such as ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentanediol, 1,5-hexanediol, 2,5-hexanediol, 1,6-hexanediol, 1,7-heptanediol, 1,8-octanediol, 1,9-nonanediol, 1,10-decanediol, 1,11-undecanediol, 1,12-dodecanediol, 1,4-cyclohexanediol, 1,4-cyclohexanedimethanol, hydroquinone, resorcinol, bisphenol-A, bisphenol-F, and 4,4′-biphenol; polyether polyols such as polyethylene glycol, polypropylene glycol, and polyoxytetramethylene glycol; and polyester polyols such as polyhexamethylene adipate, polyhexamethylene succinate, and polycaprolactone.

As the polyisocyanate, the same ones as the polyisocyanate having a hydrophilic group that can be used for the polyether-based urethane resin can be used.

As the polyol having a hydrophilic group, the same ones as the polyol having a hydrophilic group that can be used for the polyether-based urethane resin can be used.

Examples of the chain extender such as a polyamine include diamines such as ethylenediamine, 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, and 1,4-cyclohexanediamine; N-hydroxymethylaminoethylamine, N-hydroxyethylaminoethylamine, N-hydroxypropylaminopropylamine, N-ethylaminoethylamine, and N-methylaminopropylamine; diethylenetriamine, dipropylenetriamine, and triethylenetetramine; hydrazine, N,N′-dimethylhydrazine, and 1,6-hexamethylenebishydrazine; succinic acid dihydrazide, adipic acid dihydrazide, glutaric acid dihydrazide, sebacic acid dihydrazide, and isophthalic acid dihydrazide; and β-semicarbazide propionic acid hydrazide, 3-semicarbazide-propyl-carbazate, and semicarbazide-3-semicarbazidomethyl-3,5,5-trimethylcyclohexane. It is preferable to use hydrazine in order to obtain an ink that is less likely to cause the clogging and can produce printed matter having excellent washing fastness.

The polyamine is preferably used such that the equivalent of amino groups of the polyamine is preferably in a range of 0.01 to 1.0 (equivalent ratio) with respect to the equivalent of isocyanate groups of a urethane prepolymer as a reaction product of the polyol and the polyisocyanate, more preferably used in a range of 0.01 to 0.5 (equivalent ratio), and more preferably 0.01 to 0.3 (equivalent ratio).

As the polyester-based urethane resin, a reaction product of a polyol containing a polyester polyol and a polyisocyanate can be used. As the polyester polyol, a reaction product of a diol and a dicarboxylic acid, a product obtained by a dehydration-condensation reaction of a hydroxycarboxylic acid alone or a combination with a diol or a dicarboxylic acid, a ring-opening polymerization reaction product of a cyclic ester compound such as ε-caprolactone, and the like can be used.

Examples of the diol include ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, triethylene glycol, tetraethylene glycol, polyethylene glycol, dipropylene glycol, tripropylene glycol, polypropylene glycol, bis(hydroxyethoxy)benzene, 1,4-cyclohexanediol, 1,4-cyclohexanedimethanol, bisphenol A, hydrogenated bisphenol A, hydroquinone, and alkylene oxide adducts of these.

Examples of the dicarboxylic acid include succinic acid, adipic acid, azelaic acid, sebacic acid, dodecanedicarboxylic acid, maleic acid, fumaric acid, 1,3-cyclopentanedicarboxylic acid, 1,4-cyclohexanedicarboxylic acid, terephthalic acid, isophthalic acid, phthalic acid, 1,4 naphthalene dicarboxylic acid, 2,5-naphthalene dicarboxylic acid, 2,6-naphthalene dicarboxylic acid, naphthalic acid, biphenyldicarboxylic acid, and 1,2-bis(phenoxy)ethane-p,p′-dicarboxylic acid.

Examples of the hydroxycarboxylic acid include p-hydroxybenzoic acid and p-(2-hydroxyethoxy)benzoic acid.

Examples of the other polyols include, in addition to those described above, ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, triethylene glycol, tetraethylene glycol, polyethylene glycol, dipropylene glycol, tripropylene glycol, bis(hydroxyethoxy)benzene, 1,4-cyclohexanediol, 1,4-cyclohexanedimethanol, bisphenol A, hydrogenated bisphenol A, hydroquinone, and alkylene oxide adducts of these, and polyols with a relatively low molecular weight such as glycerin, trimethylolethane, trimethylolpropane, sorbitol, and pentaerythritol, which can be used alone or two or more of which can be used in combination.

The acrylic resins are not limited to particular acrylic resins, and homopolymers or copolymers of (meth)acrylate, copolymers of (meth)acrylate and other vinyl monomers, and the like can be used.

### (Pigment)

The ink jet textile printing ink of the present invention contains a pigment.

The pigment is not limited to a particular pigment, and any known and customary pigments such as organic pigments or inorganic pigments normally used in conventional screen textile printing and aqueous ink jet recording inks can be used. As the pigment, a colorant in which the pigment is coated with a resin can also be used. Note that in the present invention, the color ink includes pigments having colors other than white, and includes a black ink.

As the pigment, both non-acid-treated pigments and acid-treated pigments can be used, and both dry powder and wet cake forms can be used.

As the inorganic pigments, for example, iron oxide, titanium oxide, carbon black produced by the contact method, the furnace method, the thermal method, or other methods, and the like can be used.

Examples of the organic pigments include azo pigments (including azo lake, insoluble azo pigments, condensed azo pigments, and chelated azo pigments), polycyclic pigments (for example, phthalocyanine pigments, perylene pigments, perinone pigments, anthraquinone pigments, quinacridone pigments, dioxazine pigments, thioindigo pigments, isoindoline pigments, and quinophthalone pigments), lake pigments (for example, basic dye type chelates and acidic dye type chelates), nitro pigments, nitroso pigments, and aniline black.

Specific examples of the pigment, the pigment for use in black inks, include carbon blacks such as No. 2300, No. 2200B, No. 900, No. 980, No. 960, No. 950, No. 33, No. 40, No. 45, No. 45L, No. 52, HCF88, MCF88, MA7, MA8, MA100, and the like manufactured by Mitsubishi Chemical Corporation, Raven 5750, Raven 5250, Raven 5000, Raven 3500, Raven 1255, Raven 700, and the like manufactured by Columbia, Regal 400R, Regal 330R, Regal 660R, Mogul L, Mogul 700, Monarch 800, Monarch 880, Monarch 900, Monarch 1000, Monarch 1100, Monarch 1300, Monarch 1400, and the like manufactured by Cabot Corporation, Color Black FW1, FW2, FW2V, FW18, FW200, S150, S160, S170, Printex 35, U, V, 1400U, Special Black 6, 5, 4, 4A, NIPEX 150, NIPEX 160, NIPEX 170, NIPEX 180, and the like manufactured by Degussa.

Specific examples of the pigment for use in yellow inks include C.I. Pigment Yellow 1, 2, 12, 13, 14, 16, 17, 73, 74, 75, 83, 93, 95, 97, 98, 109, 110, 114, 120, 128, 129, 138, 150, 151, 154, 155, 174, 180, and 185.

Specific examples of the pigment for use in magenta inks include C.I. Pigment Violet 19, C.I. Pigment Red 5, 7, 12, 48 (Ca), 48 (Mn), 57(Ca), 57:1, 112, 122, 123, 146, 168, 176, 184, 185, 202, and 209, and mixtures or solid solutions of at least two or more pigments selected from these pigments.

Specific examples of the pigment for use in cyan inks include C.I. Pigment Blue 1, 2, 3, 15, 15:3, 15:4, 15:6, 16, 22, 60, 63, and 66.

As specific examples of the pigment for use in red inks, one or two or more selected from the group consisting of C.I. Pigment Red 17, 49:2, 112, 149, 150, 177, 178, 179, 188, 254, 255, and 264 are suitably used.

Specific examples of the pigment for use in orange inks include C.I. Pigment Orange 1, 2, 5, 7, 13, 14, 15, 16, 24, 34, 36, 38, 40, 43, 63, 64, 71, 73, and 81.

Specific examples of the pigment for use in green inks include C.I. Pigment Green 7, 10, 36, 58, and 59.

Specific examples of the pigment for use in violet inks include C.I. Pigment Violet 19, 23, 32, 33, 36, 38, 43, and 50.

To demonstrate the effect of the present invention to the maximum, the ink of the present invention is preferably a white ink containing a white pigment as the pigment. Specific examples of the white pigment that can be used for the white ink include sulfates and carbonates of alkaline earth metals, silicas such as fine silicic acid and synthetic silicates, calcium silicate, alumina, alumina hydrates, titanium oxide, zinc oxide, talc, and clay. These may be surface treated. Among them, titanium oxide is preferred, and alumina-treated titanium oxide is more preferred.

As the pigment, those described above can be used alone or two or more of them can be used in combination.

It is preferable that means be taken to cause the pigment to be well dispersed in an aqueous medium such as water in order to cause it to be present stably in the ink.

Examples of the means include:
(i) a method of dispersing the pigment together with a pigment dispersant in an aqueous medium such as water by a dispersion method described below; and
(ii) a method of dispersing and/or dissolving a self-dispersing pigment in which a dispersibility-imparting group (a hydrophilic functional group and/or a salt thereof) is bonded directly or indirectly via an alkyl group, alkyl ether group, aryl group, or the like to the surface of the pigment in an aqueous medium such as water.

As the self-dispersing pigment, for example, those in which the pigment is physically treated or chemically treated to bond (graft) a dispersibility-imparting group or active species having a dispersibility-imparting group to the surface of the pigment can be used. The self-dispersing pigment can be produced by, for example, vacuum plasma treatment, oxidation treatment with hypohalous acid and/or hypohalite or oxidation treatment with ozone, a wet oxidation method in which the pigment surface is oxidized with an oxidant in water, or a method of bonding a carboxy group via a phenyl group by bonding p-aminobenzoic acid to the pigment surface.

Since aqueous inks containing the self-dispersing pigment do not need to contain the pigment dispersant, there is almost no foaming or the like caused by the pigment dispersant, and inks with excellent ejection stability are easily prepared. In addition, aqueous inks containing the self-dispersing pigment are easy to handle, can contain the pigment in a larger amount because a significant viscosity increase caused by the pigment dispersant is inhibited, and can be used to produce printed matter with high print density.

As the self-dispersing pigment, commercially available products can also be used, and examples of such commercially available products include Microjet CW-1 (product name; manufactured by Orient Chemical Industries Co., Ltd.), CAB-0-JET 200 and CAB-O-JET 300 (product names; manufactured by Cabot Corporation).

In order to maintain excellent dispersion stability of the pigment and to improve the print density and washing resistance of printed matter, the pigment is preferably used in a range of 1% by mass to 20% by mass, and more preferably used in a range of 2% by mass to 15% by mass with respect to the total amount of the ink.

### (Pigment Dispersant)

The pigment dispersant has the function of dispersing the pigment.

Examples of the pigment dispersant include polyvinyl alcohols, polyvinyl pyrrolidones, acrylic resins such as poly(acrylic acid-co-acrylate), styrene-acrylic resins such as poly(styrene-co-acrylic acid), poly(styrene-co-methacrylic acid), poly(styrene-co-methacrylic acid-co-acrylate), poly(styrene-co-α-methylstyrene-co-acrylic acid), and poly(styrene-co-α-methylstyrene-co-acrylic acid-co-acrylate); aqueous resins such as poly(styrene-co-maleic acid), poly(styrene-co-maleic anhydride), and poly(vinylnaphthalene-co-acrylic acid), and salts of the aqueous resins. Examples of the pigment dispersant include the Ajisper PB series from Ajinomoto Fine-Techno Co., Inc., the Disperbyk series from BYK-Chemie Japan K.K., the EFKA series from BASF, the SOLSPERSE series from Lubrizol Japan Limited, and the TEGO series from Evonik.

As the pigment dispersant, a polymer (E) described below can also be used in order to significantly reduce coarse particles, and as a result, impart good ejection stability required when the ink is ejected by an ink jet method.

As the polymer (E), those having an anionic group can be used, and among them, it is preferable to use a polymer with a number average molecular weight in a range of 1,000 to 6,000, which has a solubility in water of 0.1 g/100 ml or less and is capable of forming fine particles in water when the neutralization rate of the anionic group with a basic compound is 100%.

The solubility in water of the polymer (E) was defined as follows. That is, 0.5 g of the polymer (E), the particle size of which had been adjusted to a range of 250 μm to 90 μm using sieves with a mesh opening of 250 μm and 90 μm, was enclosed in a bag made with a 400-mesh wire net, immersed in 50 ml of water, and gently stirred and left for 24 hours at a temperature of 25° C. After immersion for 24 hours, the 400-mesh wire net enclosing the polymer (E) was dried in a dryer set at 110° C. for 2 hours. A change in the weight of the 400-mesh wire net enclosing the polymer (E) before and after immersion in water was measured, and the solubility was calculated using the following expression.

$$[ Expression 1 ]$$

$$Solubility ( g / 100 mL ) = ( Polymer - enclosed 400 - mesh wire net before immersion ( g ) - Polymer - enclosed 400 - mesh wire net after immersion ( g ) ) \times 2$$

In the present invention, whether fine particles are formed in water when the neutralization rate of the anionic group with a basic compound is 100% was determined as follows.
(1) The acid value of the polymer (E) is measured in advance by the method for measuring the acid value based on JIS test method K 0070-1992. Specifically, 0.5 g of the polymer (E) is dissolved in tetrahydrofuran and titrated with a 0.1 M potassium hydroxide alcohol solution using phenolphthalein as an indicator to determine the acid value.
(2) After adding 1 g of the polymer (E) to 50 ml of water, a 0.1 mol/L aqueous potassium hydroxide solution just enough to neutralize 100% of the obtained acid value is added to perform 100% neutralization.
(3) The 100% neutralized solution is ultrasonicated in an ultrasonic cleaner (Ultrasonic Cleaner US-102 from SND Co., Ltd., 38 kHz self-excited oscillation) for 2 hours at a temperature of 25° C., and is then left to stand at room temperature for 24 hours.

After being left to stand for 24 hours, a sample liquid obtained by sampling a liquid present at a depth of 2 cm from the liquid surface is determined whether light scattering information due to the formation of fine particles is obtained using a dynamic light scattering particle size distribution analyzer (dynamic light scattering particle size analyzer “Microtrac Particle Size Distribution Analyzer UPA-ST150” manufactured by Nikkiso Co., Ltd.), thereby checking for the presence of fine particles.

To further improve the stability in water of the fine particles formed by the polymer (E), the particle size of the fine particles is preferably in a range of 5 nm to 1,000 nm, more preferably in a range of 7 nm to 700 nm, and most preferably in a range of 10 nm to 500 nm. There is a tendency that as the particle size distribution of the fine particles becomes narrower, the dispersion stability becomes better. However, even when the particle size distribution is wide, an ink with better dispersion stability than before can be obtained. Note that the particle size and the particle size distribution were measured using a dynamic light scattering particle size distribution analyzer (dynamic light scattering particle size analyzer “Microtrac Particle Size Distribution Analyzer UPA-ST150” manufactured by Nikkiso Co., Ltd.) in the same manner as the method for measuring the fine particles.

The neutralization rate of the polymer (E) was determined by the following expression.

$$[ Expression 2 ]$$

$$Neutralization rate ( \% ) = \{ ( Mass of basic compound ( g ) \times 56 \times 1 , 000 ) / ( Acid value of the polymer ( E ) ( mgKOH / g ) \times Equivalent of basic compound ) \times Mass of the polymer ( E ) ( g ) \} \times 100$$

The acid value of the polymer (E) was measured based on JIS test method K 0070-1992. Specifically, to determine the acid value, 0.5 g of a sample was dissolved in tetrahydrofuran and titrated with a 0.1 M potassium hydroxide alcohol solution using phenolphthalein as an indicator.

It is preferable to use the polymer (E) with a number average molecular weight in a range of 1,000 to 6,000, the number average molecular weight is more preferably 1,300 to 5,000, and in order to obtain an ink that can effectively inhibit flocculation or the like of the pigment in a solvent (C) and has good dispersion stability of the pigment, the number average molecular weight is more preferably 1,500 to 4,500.

Note that the number average molecular weight is a value in terms of polystyrene measured by gel permeation chromatography (GPC), and specifically a value measured under the following conditions.

### (Method for Measuring Number Average Molecular Weight (Mn))

Measurement was performed under the following conditions by a gel permeation chromatography (GPC) method.

Analysis apparatus: High-speed GPC apparatus (“HLC-8220GPC” manufactured by Tosoh Corporation)

Columns: The following columns manufactured by Tosoh Corporation, connected in series, were used.
“TSKgel G5000” (7.8 mm I.D.×30 cm)×1
“TSKgel G4000” (7.8 mm I.D.×30 cm)×1
“TSKgel G3000” (7.8 mm I.D.×30 cm)×1
“TSKgel G2000” (7.8 mm I.D.×30 cm)×1
Detector: RI (differential refractometer)
Column temperature: 40° C.
Elution solvent: Tetrahydrofuran
Flow rate: 1.0 mL/minute
Injection amount: 100 μL (a tetrahydrofuran solution with a sample concentration of 0.4% by mass)
Standard samples: The following standard polystyrenes were used to prepare a calibration curve.

### (Standard Polystyrenes)

“TSKgel Standard Polystyrene A-500” manufactured by Tosoh Corporation
“TSKgel Standard Polystyrene A-1000” manufactured by Tosoh Corporation
“TSKgel Standard Polystyrene A-2500” manufactured by Tosoh Corporation
“TSKgel Standard Polystyrene A-5000” manufactured by Tosoh Corporation
“TSKgel Standard Polystyrene F-1” manufactured by Tosoh Corporation
“TSKgel Standard Polystyrene F-2” manufactured by Tosoh Corporation
“TSKgel Standard Polystyrene F-4” manufactured by Tosoh Corporation
“TSKgel Standard Polystyrene F-10” manufactured by Tosoh Corporation
“TSKgel Standard Polystyrene F-20” manufactured by Tosoh Corporation
“TSKgel Standard Polystyrene F-40” manufactured by Tosoh Corporation
“TSKgel Standard Polystyrene F-80” manufactured by Tosoh Corporation
“TSKgel Standard Polystyrene F-128” manufactured by Tosoh Corporation
“TSKgel Standard Polystyrene F-288” manufactured by Tosoh Corporation
“TSKgel Standard Polystyrene F-550” manufactured by Tosoh Corporation

As the polymer (E), the surface tension of the ink containing it is preferably 30 dyn/cm or more, and more preferably 40 dyn/cm or more, and it is especially preferable to use one with a surface tension of 65 dyn/cm to 75 dyn/cm, which is close to the surface tension of water. Note that the surface tension is a value measured for a 100% neutralized polymer solution obtained by adding 1 g of the polymer (E) to water, and then adding a 0.1 mol/L aqueous potassium hydroxide solution just enough to neutralize 100% of the obtained acid value.

As the polymer (E), a polymer that is insoluble or poorly soluble in water in an unneutralized state and forms fine particles in a 100% neutralized state can be used, and it is not limited to a particular polymer so long as it is a polymer having a hydrophobic group in one molecule in addition to an anionic group as a hydrophilic group.

Such a polymer includes a block polymer having a polymer block having a hydrophobic group and a polymer block having an anionic group. In the polymer (E), the number of the anionic groups and the solubility in water are not necessarily specified by the acid value or the number of anionic groups at the time of designing the polymer. For example, even for polymers having the same acid value, the solubility in water tends to increase for a polymer with a lower molecular weight, while the solubility in water tends to decrease for a polymer with a higher molecular weight. Therefore, in the present invention, the polymer (E) is specified by the solubility in water.

The polymer (E) may be a homopolymer, but it is preferably a copolymer, which may be a random polymer, a block polymer, or an alternating polymer, with a block polymer being preferred among them. The polymer may be a branched polymer, but it is preferably a linear polymer.

The polymer (E) is preferably a vinyl polymer in view of the degree of freedom of design, and as the method for producing a vinyl polymer having a molecular weight and solubility characteristics desired in the present invention, it is preferably produced using “living polymerization” such as living radical polymerization, living cationic polymerization, or living anionic polymerization.

Among them, the polymer (E) is preferably a vinyl polymer produced using a (meth)acrylate monomer as one of the raw materials, and as a method for producing such a vinyl polymer, living radical polymerization and living anionic polymerization are preferred, and further from the viewpoint that the molecular weight and each segment of the block polymer can be designed more precisely, living anionic polymerization is preferred.

The polymer (E) produced by living anionic polymerization is specifically a polymer represented by General Formula (3).

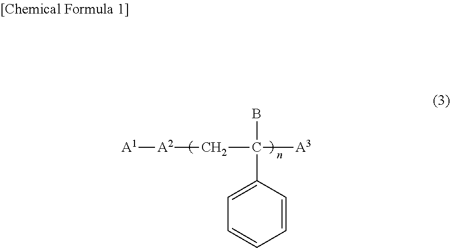

In General Formula (3), A1 represents an organolithium initiator residue, A2 represents a polymer block having a hydrophobic group, A3 represents a polymer block containing an anionic group, n represents an integer of 1 to 5, and B represents an aromatic group or an alkyl group.

In General Formula (3), A1 represents an organolithium initiator residue. Specific examples of the organolithium initiator include alkyl lithium such as methyl lithium, ethyl lithium, propyl lithium, butyl lithium (such as n-butyl lithium, sec-butyl lithium, iso-butyl lithium, or tert-butyl lithium), pentyl lithium, hexyl lithium, methoxymethyl lithium, and ethoxymethyl lithium; phenylalkylene lithium such as benzyl lithium, α-methylstyryl lithium, 1,1-diphenyl-3-methylpentyl lithium, 1,1-diphenylhexyl lithium, and phenylethyl lithium; alkenyl lithium such as vinyl lithium, allyl lithium, propenyl lithium, and butenyl lithium; alkynyl lithium such as ethynyl lithium, butynyl lithium, pentynyl lithium, and hexynyl lithium; aryl lithium such as phenyl lithium and naphthyl lithium; heterocyclic lithium such as 2-thienyl lithium, 4-pyridyl lithium, and 2-quinolyl lithium; and alkyl lithium magnesium complexes such as tri(n-butyl) magnesium lithium and trimethyl magnesium lithium.

In the organolithium initiator, the bond between an organic group and lithium is cleaved to generate an active end on the organic group side, from which polymerization is initiated. Therefore, to the resulting polymer end, the organic group derived from organolithium is bonded. In the present invention, the organic group derived from organolithium bonded to the polymer end is referred to as an organolithium initiator residue. For example, for a polymer obtained by using methyl lithium as an initiator, the organolithium initiator residue is a methyl group, and for a polymer obtained by using butyl lithium as an initiator, the organolithium initiator residue is a butyl group.

In General Formula (3) above, A2 represents a polymer block having a hydrophobic group. In addition to the purpose of balancing moderate solubility as described above, A2 is preferably a group with high adsorption to the pigment when in contact with the pigment, and from this viewpoint, A2 is preferably a polymer block of a monomer having an aromatic ring or a heterocyclic ring.

The polymer block of the monomer having an aromatic ring or a heterocyclic ring is specifically a polymer block of a homopolymer or a copolymer obtained through homopolymerization or copolymerization of a monomer having an aromatic ring, such as a styrene-based monomer, or a monomer having a heterocyclic ring, such as a vinyl pyridine-based monomer.

Examples of the monomer having an aromatic ring include styrene-based monomers such as styrene, o-methylstyrene, p-methylstyrene, p-tert-butylstyrene, p-tert-butoxystyrene, m-tert-butoxystyrene, p-tert-(1-ethoxymethyl)styrene, m-chlorostyrene, p-chlorostyrene, p-fluorostyrene, α-methylstyrene, and p-methyl-α-methylstyrene, vinylnaphthalene, and vinylanthracene.

Examples of the monomer having a heterocyclic ring include vinylpyridine-based monomers such as 2-vinylpyridine and 4-vinylpyridine. These monomers can be used alone or two or more can be used in a mixed manner.

In General Formula (3) above, A3 represents a polymer block containing an anionic group. A3 has the purpose of imparting moderate solubility as described above, and also has the purpose of imparting dispersion stability in water when made into a pigment dispersion.

Examples of the anionic group in the polymer block A3 include a carboxy group, a sulfonic acid group, and a phosphoric acid group. Among them, a carboxy group is preferred due to their preparation, a wide variety of monomer types, and availability. In addition, two carboxy groups may be dehydrated and condensed intra- or intermolecularly to form an acid anhydride group.

The method for introducing the anionic group of A3 is not limited to a particular method. For example, when the anionic group is a carboxy group, it may be a polymer block (PB1) of a homopolymer or copolymer obtained by homopolymerization of (meth)acrylic acid or copolymerization with other monomers, or a polymer block (PB2) of a homopolymer or copolymer obtained by homopolymerization of (meth)acrylate having protecting groups that can be regenerated to anionic groups by performing deprotection or copolymerization with other monomers in which some or all of the protecting groups that can be regenerated to anionic groups are regenerated to anionic groups.

Note that the term (meth)acrylic acid used in the polymer block A3 represents the generic term for acrylic acid and methacrylic acid, and the term (meth)acrylate represents the generic term for acrylate and methacrylate.

Specific examples of (meth)acrylic acid and (meth)acrylate include (meth)acrylic acid, methyl (meth)acrylate, ethyl (meth)acrylate, iso-propyl (meth)acrylate, allyl (meth)acrylate, n-butyl (meth)acrylate, iso-butyl (meth)acrylate, sec-butyl (meth)acrylate, tert-butyl (meth)acrylate, n-amyl (meth)acrylate, iso-amyl (meth)acrylate, n-hexyl (meth)acrylate, n-octyl (meth)acrylate, 2-ethylhexyl (meth)acrylate, n-lauryl (meth)acrylate, n-tridecyl (meth)acrylate, n-stearyl (meth)acrylate, phenyl (meth)acrylate, benzyl (meth)acrylate, cyclohexyl (meth)acrylate, 4-tert-butyl cyclohexyl (meth)acrylate, isobornyl (meth)acrylate, tricyclodecanyl (meth)acrylate, dicyclopentadienyl (meth)acrylate, adamantyl (meth)acrylate, glycidyl (meth)acrylate, tetrahydrofurfuryl (meth)acrylate, 2-methoxyethyl (meth)acrylate, 2-ethoxyethyl (meth)acrylate, dimethylaminoethyl (meth)acrylate, diethylaminoethyl (meth)acrylate, trifluoroethyl (meth)acrylate, tetrafluoropropyl (meth)acrylate, pentafluoropropyl (meth)acrylate, octafluoropentyl (meth)acrylate, pentadecafluorooctyl (meth)acrylate, heptadecafluorodecyl (meth)acrylate, N,N-dimethyl (meth)acrylamide, (meth)acryloyl morpholine, (meth)acrylonitrile, and polyalkylene oxide group-containing (meth)acrylates such as polyethylene glycol (meth)acrylate, polypropylene glycol (meth)acrylate, polyethylene glycol-polypropylene glycol (meth)acrylate, polyethylene glycol-polybutylene glycol (meth)acrylate, polypropylene glycol-polybutylene glycol (meth)acrylate, methoxy polyethylene glycol (meth)acrylate, ethoxy polyethylene glycol (meth)acrylate, butoxy polyethylene glycol (meth)acrylate, octoxy polyethylene glycol (meth)acrylate, lauroxy polyethylene glycol (meth)acrylate, stearoxy polyethylene glycol (meth)acrylate, phenoxy polyethylene glycol (meth)acrylate, methoxy polypropylene glycol (meth)acrylate, and octoxy polyethylene glycol-polypropylene glycol (meth)acrylate. These monomers can be used alone or two or more can be used in a mixed manner.

In the living anionic polymerization method, when the used monomer is a monomer having a group having an active proton such as an anionic group, the active end of the living anionic polymerization polymer immediately reacts with these groups having an active proton, and deactivated, and thus the polymer is not obtained. In the living anionic polymerization, since it is difficult to polymerize the monomer having a group having an active proton as it is, it is preferable to polymerize it with the group having an active proton protected, and then regenerate the group having an active proton by deprotecting the protecting group.

For this reason, in the polymer block A3, it is preferable to use a monomer containing (meth)acrylate having a protecting group that can be regenerated to an anionic group by performing deprotection. The use of this monomer can prevent the inhibition of polymerization described above during polymerization. The anionic group protected by the protecting group can be regenerated to the anionic group by performing deprotection after obtaining the block polymer.

For example, when the anionic group is a carboxy group, the carboxy group can be regenerated by esterifying the carboxy group and deprotecting it by hydrolysis or the like as a post-process. The protecting group that can be converted to the carboxy group in this case is preferably a group having an ester bond, and examples thereof include primary alkoxycarbonyl groups such as a methoxycarbonyl group, an ethoxycarbonyl group, an n-propoxycarbonyl group, and an n-butoxycarbonyl group; secondary alkoxycarbonyl groups such as an isopropoxycarbonyl group and a sec-butoxycarbonyl group; tertiary alkoxycarbonyl groups such as a t-butoxycarbonyl group; phenylalkoxycarbonyl groups such as a benzyloxycarbonyl group; and alkoxyalkylcarbonyl groups such as an ethoxyethylcarbonyl group.

When the anionic group is a carboxy group, examples of the monomer that can be used include alkyl (meth)acrylates such as methyl (meth)acrylate, ethyl (meth)acrylate, n-propyl (meth)acrylate, isopropyl (meth)acrylate, n-butyl (meth)acrylate, sec-butyl (meth)acrylate, isobutyl (meth)acrylate, t-butyl (meth)acrylate, 2-ethylhexyl (meth)acrylate, decyl (meth)acrylate, undecyl (meth)acrylate, dodecyl (meth)acrylate (lauryl (meth)acrylate), tridecyl (meth)acrylate, pentadecyl (meth)acrylate, hexadecyl (meth)acrylate, heptadecyl (meth)acrylate, octadecyl (meth)acrylate (stearyl (meth)acrylate), nonadecyl (meth)acrylate, and icosanyl (meth)acrylate; phenylalkylene (meth)acrylates such as benzyl (meth)acrylate; and alkoxyalkyl (meth)acrylates such as ethoxyethyl (meth)acrylate. These (meth)acrylates can be used alone or two or more can be used in combination. Among these (meth)acrylates, t-butyl (meth)acrylate and benzyl (meth)acrylate are preferably used because they provide an easy conversion reaction to the carboxy group. In consideration of industrial accessibility, t-butyl (meth)acrylate is more preferred.

In General Formula (3), B represents an aromatic group or an alkyl group with 1 to 10 carbon atoms. Also, n represents an integer of 1 to 5.

In the living anionic polymerization method, when a (meth)acrylate monomer is attempted to be polymerized directly to the active end of a styrene-based polymer with strong nucleophilic properties, it may not be polymerized due to nucleophilic attack on the carbonyl carbon. For this reason, when the (meth)acrylate monomer is polymerized to A1-A2 described above, a reaction adjuster is used to adjust nucleophilicity, and then the (meth)acrylate monomer is polymerized. B in General Formula (3) is a group derived from the reaction adjuster. Specific examples of the reaction adjuster include diphenylethylene, α-methylstyrene, and p-methyl-α-methylstyrene.

The living anionic polymerization method can be carried out in a batch system as used in conventional free radical polymerization by adjusting the reaction conditions, or it can be a continuous polymerization method using a microreactor. The microreactor can narrow the molecular weight distribution of the polymer to be produced because the mixing of a polymerization initiator and the monomer is good, and thus the reaction starts simultaneously, the temperature is uniform, and the polymerization rate can be aligned. At the same time, it is easy to produce a block copolymer in which both block components do not mix because a growing end is stable. In addition, the controllability of a reaction temperature is good, thus making it easy to inhibit side reactions.

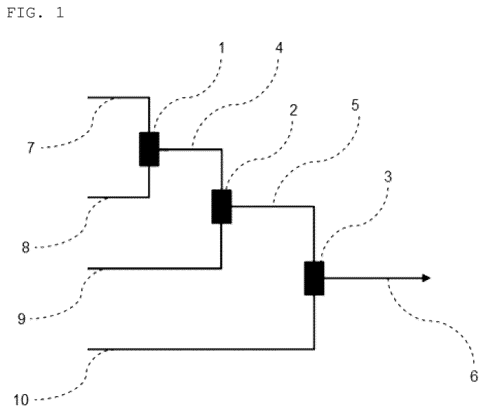

A general method of living anionic polymerization using the microreactor will be described with reference to FIG. 1, which is a schematic diagram of the microreactor.

A first monomer and a polymerization initiator that initiates polymerization are introduced from tube reactors P1 and P2 (7 and 8 in FIG. 1), respectively, into a T-shaped micromixer M1 (1 in FIG. 1) including a flow path that can mix a plurality of liquids, and the first monomer is subjected to living anionic polymerization in the T-shaped micromixer M1 to form a first polymer (Step 1).

Next, the resulting first polymer is transferred to a T-shaped micromixer M2 (2 in FIG. 1), and in the mixer M2, the growing end of the resulting polymer is trapped by a reaction adjuster introduced from a tube reactor P3 (9 in FIG. 1) to perform reaction adjustment (Step 2).

Note that the number of n in General Formula (3) above can be controlled by the type and the use amount of the reaction adjuster.

Next, the reaction-adjusted first polymer in the T-shaped micromixer M2 is transferred to a T-shaped micromixer M3 (3 in FIG. 1), and in the mixer M3, a second monomer introduced from a tube reactor P4 and the reaction-adjusted first polymer are continuously subjected to living anionic polymerization (Step 3).

The reaction is then quenched with a compound having an active proton such as methanol to produce a block copolymer.

When the polymer (E) represented by General Formula (3) of the present invention is produced with the microreactor, a monomer having an aromatic ring or a heterocyclic ring is used as the first monomer, and is reacted by an organolithium initiator as the initiator, thereby obtaining a polymer block of the monomer having an aromatic ring or a heterocyclic ring of A2 described above (the organic group, which is the organolithium initiator residue of A1 described above, is bonded to one end of the polymer block A2).

Next, after adjusting the reactivity of the growing end using the reaction adjuster, a monomer containing (meth)acrylate having the protecting group that can be regenerated to the anionic group is reacted as the second monomer to obtain a polymer block.

After this, the anionic group is regenerated by a deprotection reaction such as hydrolysis to obtain A3 described above, that is, a polymer block containing an anionic group.

A method of regenerating the ester bond of the protecting group that can be regenerated to the anionic group to the anionic group by the deprotection reaction such as hydrolysis will be described in detail.

The hydrolysis reaction of the ester bond proceeds under both acidic conditions and basic conditions, but the conditions differ somewhat depending on the group having an ester bond. For example, when the group having an ester bond is a primary alkoxycarbonyl group such as a methoxycarbonyl group or a secondary alkoxycarbonyl group such as an isopropoxycarbonyl group, a carboxy group can be obtained by performing hydrolysis under basic conditions. In this case, examples of a basic compound to make basic conditions include metal hydroxides such as sodium hydroxide and potassium hydroxide.

When the group having an ester bond is a tertiary alkoxycarbonyl group such as a t-butoxycarbonyl group, a carboxy group can be obtained by performing hydrolysis under acidic conditions. In this case, examples of an acidic compound to make acidic conditions include mineral acids such as hydrochloric acid, sulfuric acid, and phosphoric acid; Brønsted acids such as trifluoroacetic acid; and Lewis acids such as trimethylsilyl triflate. The reaction conditions for hydrolysis of the t-butoxycarbonyl group under acidic conditions are disclosed, for example, in “The Chemical Society of Japan, 5th ed. Experimental Chemistry Course 16: Synthesis of Organic Compounds IV.”

Another method for converting the t-butoxycarbonyl group to a carboxy group is a method of using a cation exchange resin in place of the acid described above. Examples of the cation exchange resin include resins having acid groups such as a carboxy group (—COOH) and a sulfo group (—SO₃H) on a side chain of a polymer chain. Among these, the cation exchange resin that exhibits strong acidity having a sulfo group on the side chain of the resin is preferred because it can speed up the progress of the reaction. Examples of commercially available products of the cation exchange resin that can be used in the present invention include a strongly acidic cation exchange resin “Amberlite” manufactured by Organo Corporation. The amount of this cation exchange resin used is preferably in a range of 5 parts by mass to 200 parts by mass, and more preferably in a range of 10 parts by mass to 100 parts by mass with respect to 100 parts by mass of the polymer represented by General Formula (3) above because it enables effective hydrolysis.

When the group having an ester bond is a phenylalkoxycarbonyl group such as a benzyloxycarbonyl group, it can be converted to a carboxy group by performing a hydrogenation reduction reaction. In this case, the phenylalkoxycarbonyl group can be regenerated to a carboxy group quantitatively by reacting it under room temperature, in the presence of a palladium catalyst such as palladium acetate, and using hydrogen gas as a reducing agent as reaction conditions.

As described above, the reaction conditions for the conversion to a carboxy group differ depending on the type of the group having an ester bond, so that, for example, a polymer obtained by copolymerization using t-butyl (meth)acrylate and n-butyl (meth)acrylate as raw materials for A3 will have a t-butoxycarbonyl group and an n-butoxycarbonyl group. Since the n-butoxycarbonyl group is not hydrolyzed under acidic conditions where the t-butoxycarbonyl group is hydrolyzed, only the t-butoxycarbonyl group can be selectively hydrolyzed and deprotected to a carboxy group. Therefore, it is possible to adjust the acid value of the hydrophilic block (A3) by selecting as appropriate the monomer containing (meth)acrylate having a protecting group that can be regenerated to an anionic group, which is the raw material monomer of A3.

In addition, in the polymer (E) represented by General Formula (3) above, it is advantageous to be a block copolymer in which the polymer block (A2) and the polymer block (A3) are regularly bonded as a group of a certain length, rather than a random copolymer in which the polymer blocks are randomly arranged and bonded in order to improve the stability of the aqueous pigment dispersion in which the pigment is dispersed in water by the polymer (E). The aqueous pigment dispersion is a raw material for use in the production of the ink, and may be a liquid in which the pigment is dispersed in water at a high concentration by the polymer (E). The molar ratio A2:A3 of the polymer block (A2) to the polymer block (A3) is preferably in a range of 100:10 to 100:500, and, for example, in order to obtain an ink that can maintain good ejection stability required when the ink is ejected by an ink jet method, and can produce printed matter having even better color development and the like, A2:A3=100:10 to 100:450 is more preferred.

In the polymer (E) represented by General Formula (3) above, the number of monomers having an aromatic ring or a heterocyclic ring constituting the polymer block (A2) is preferably in a range of 5 to 40, yet preferably in a range of 6 to 30, and most preferably in a range of 7 to 25. The number of anionic groups constituting the polymer block (A3) is preferably in a range of 3 to 20, yet preferably in a range of 4 to 17, and most preferably in a range of 5 to 15.

When the molar ratio A2:A3 of the polymer block (A2) to the polymer block (A3) is represented as the molar ratio of the number of moles having an aromatic ring or a heterocyclic ring constituting the polymer block (A2) to the number of moles of anionic groups constituting (A3), 100:7.5 to 100:400 is preferred.

The acid value of the polymer (E) represented by General Formula (3) above is preferably 40 mgKOH/g to 400 mgKOH/g, more preferably 40 mgKOH/g to 300 mgKOH/g, and, for example, in order to obtain an ink that can maintain good ejection stability required when the ink is ejected by an ink jet method, and can produce printed matter having even better scratch resistance and the like, the acid value is more preferably 40 mgKOH/g to 190 mgKOH/g.

Note that the acid value of the polymer in the present invention is the acid value by the same method for measuring the acid value as the method for measuring fine particles of the polymer (E).

In the ink, the anionic group of the polymer (E) is preferably neutralized.

As the basic compound that neutralizes the anionic group of the polymer (E), any known and customary ones can be used, and, for example, inorganic basic substances such as alkali metal hydroxides such as sodium hydroxide and potassium hydroxide, and organic basic compounds such as ammonia, triethylamine, and alkanolamine can be used.

The amount of neutralization of the polymer (E) present in the aqueous pigment dispersion is not required to be 100% neutralized with respect to the acid value of the polymer. Specifically, the polymer (E) is preferably neutralized such that the neutralization rate is 20% to 200%, with 80% to 150% being yet preferred.

The polymer (E) can also be used as a dispersion aid in the ink, rather than as a dispersant for the aqueous pigment dispersion, which is preferred. The use of the polymer (E) as the dispersion aid can improve the long-term dispersion stability of the pigment and also improves circulation filtration properties. In this case, the polymer (E) can be added during the production of the pigment dispersion or can also be added when made into the ink. When the polymer (E) is used as the dispersion aid, the ratio among the pigment, the dispersant, and the polymer (E) is preferably pigment:dispersant:polymer (E)=1:0.03:0.01 to 1:0.5:0.2.

### (Other Ink Components)

The ink jet textile printing ink of the present invention may contain other ink components other than the pigment and the binder resin. As the other ink components, those containing other additives such as water, water-soluble solvents, surfactants, dispersion aids, sugars, preservatives, viscosity adjusters, pH adjusters, chelating agents, dispersion aids, antioxidants, and UV absorbers can be used as needed.

### (Water)

Specific examples of the water include pure water such as ion exchanged water, ultrafiltered water, reverse osmosis water, and distilled water and ultrapure water.

### (Water-Soluble Solvent)

Examples of the water-soluble solvents include glycerin, diglycerin, polyglycerin, diglycerin fatty acid esters, polyoxypropylene (n) polyglyceryl ether, polyoxyethylene (n) polyglyceryl ether, acetone, methyl ethyl ketone, methyl butyl ketone, methyl isobutyl ketone, methanol, ethanol, 2-propanol, 2-methyl-1-propanol, 1-butanol, 2-methoxyethanol, tetrahydrofuran, 1,4-dioxane, 1,2-dimethoxyethane, dimethylformamide, N-methyl pyrrolidone, ethylene glycol, diethylene glycol, triethylene glycol, tetraethylene glycol, propylene glycol, polyethylene glycol, polypropylene glycol, butanediol, pentanediol, hexanediol, and diols homologous to these, lauric acid propylene glycol, diethylene glycol monoethyl ether, diethylene glycol monobutyl ether, diethylene glycol monohexyl ether, propylene glycol ether, dipropylene glycol ether, cellosolve including triethylene glycol ether, methanol, ethanol, isopropyl alcohol, 1-propanol, 2-propanol, butyl alcohol such as 1-butanol and 2-butanol, pentyl alcohol, and alcohols homologous to these, and sulfolane; lactones such as γ-butyrolactone; lactams such as N-(2-hydroxyethyl)pyrrolidone; 3-methoxy-1-butanol, 3-methyl-3-methoxy-1-butanol, 3-methoxy-3-methyl-1-butyl acetate, ethylene glycol monomethyl ether, ethylene glycol monoethyl ether, ethylene glycol monopropyl ether, ethylene glycol monobutyl ether, ethylene glycol monoisobutyl ether, ethylene glycol-t-butyl ether, propylene glycol monomethyl ether, propylene glycol monoethyl ether, propylene glycol monopropyl ether, propylene glycol monomethyl ether acetate, diethylene glycol dimethyl ether, diethylene glycol methyl ethyl ether, diethylene glycol diethyl ether, dipropylene glycol dimethyl ether, 4-methoxy-4-methyl-2-pentanone, and ethyl lactate, which can be used alone or two or more of which can be used in combination.

Among the water-soluble solvents described above, it is preferable to use glycerin, diglycerin, polyglycerin, diglycerin fatty acid esters, ethylene glycol, diethylene glycol, triethylene glycol, tetraethylene glycol, and propylene glycol, and in order to obtain an ink that easily penetrates recording media such as fabrics and dries, and can prevent drying or coagulation at a nozzle or filter in the ink circulation type ink jet head, it is preferable to use glycerin and ethylene glycol or propylene glycol in combination.

The water and the water-soluble solvents serve as an aqueous medium of the ink jet textile printing ink of the present invention. It is preferable to use the aqueous medium in a range of 50% by mass to 95% by mass with respect to the total amount of the ink, and in order to obtain an ink that prevents the ink from drying near the nozzle, facilitates adjustment of the ease of drying after landing on the recording medium, and can produce printed matter with good texture especially when used for printing on fabrics, it is particularly preferable to use the aqueous medium in a range of 65% by mass to 95% by mass. Note that the aqueous medium includes water and water-soluble solvents contained in the pigment dispersion and the binder resin.

### (Surfactant)

The surfactant can be used in order to improve the leveling properties of the ink by lowering the surface tension of the ink, for example. Furthermore, the surfactant can prevent the occurrence of mottling of printed matter by allowing the ink ejected from the ejection port of the ink jet head to wet and spread well on the surface of the fabric after landing on the fabric.

As the surfactant, various anionic surfactants, nonionic surfactants, cationic surfactants, amphoteric surfactants, and the like can be used, and anionic surfactants and nonionic surfactants are preferably used.

Examples of the anionic surfactants include alkylbenzene sulfonates, alkylphenyl sulfonates, alkylnaphthalene sulfonates, higher fatty acid salts, sulfates of higher fatty acid esters, sulfonates of higher fatty acid esters, sulfates and sulfonates of higher alcohol ethers, higher alkyl sulfosuccinates, polyoxyethylene alkyl ether carboxylates, polyoxyethylene alkyl ether sulfates, alkyl phosphates, and polyoxyethylene alkyl ether phosphates, and specific examples thereof include dodecylbenzene sulfonate, isopropylnaphthalene sulfonate, monobutylphenylphenol monosulfonate, monobutylbiphenyl sulfonate, and dibutylphenylphenol disulfonate.

Examples of the nonionic surfactants include polyoxyethylene alkyl ethers, polyoxyethylene alkyl phenyl ethers, polyoxyethylene fatty acid esters, sorbitan fatty acid esters, polyoxyethylene sorbitan fatty acid esters, polyoxyethylene sorbitol fatty acid esters, glycerin fatty acid esters, polyoxyethylene glycerin fatty acid esters, polyglycerin fatty acid esters, sucrose fatty acid esters, polyoxyethylene alkylamines, polyoxyethylene fatty acid amides, fatty acid alkylolamides, alkyl alkanolamides, acetylene glycol, oxyethylene adducts of acetylene glycol, and polyethylene glycol-polypropylene glycol block copolymers, and preferred among these are polyoxyethylene nonylphenyl ether, polyoxyethylene octylphenyl ether, polyoxyethylene dodecylphenyl ether, polyoxyethylene alkyl ethers, polyoxyethylene fatty acid esters, sorbitan fatty acid esters, polyoxyethylene sorbitan fatty acid esters, fatty acid alkylolamides, acetylene glycol, oxyethylene adducts of acetylene glycol, and polyethylene glycol-polypropylene glycol block copolymers. Among them, acetylene glycol and oxyethylene adducts of acetylene glycol are more preferred because they reduce the contact angle of ink droplets to the recording medium and produce good printed matter.

Other examples of the surfactant include silicone surfactants such as polysiloxane oxyethylene adducts; fluorosurfactants such as perfluoroalkyl carboxylates, perfluoroalkyl sulfonates, and oxyethylene perfluoroalkyl ethers; and biosurfactants such as spiculisporic acid, rhamnolipids, and lysolecithin.

As the surfactant, it is preferable to use one with an HLB in a range of 4 to 20 in order to stably maintain a state in which the surfactant is dissolved in the ink with water as the main solvent.

The surfactant is preferably used in a range of 0.001% by mass to 2% by mass, more preferably used in a range of 0.001% by mass to 1.5% by mass, and preferably used in a range of 0.1% by mass to 1.5% by mass with respect to the total amount of the ink. The ink jet ink containing the surfactant in the above range provides good wettability of the ejected droplets on the fabric surface, has sufficient wetting and spreading on the fabric, and is preferred in order to produce the effect of preventing the occurrence of mottling of the printed matter. Furthermore, the ink containing the surfactant in the above range produces the effect of improving wettability on the fabric.

Examples of the sugars include monosaccharides and polysaccharides, and glucose, mannose, fructose, ribose, xylose, arabinose, lactose, galactose, aldonic acid, glucitol, maltose, cellobiose, sucrose, trehalose, maltotriose, and the like, and alginic acid and salts thereof, cyclodextrins, and celluloses can be used.

Examples of the preservatives include sodium benzoate, sodium pentachlorophenol, sodium 2-pyridinthiol-1-oxide, sodium sorbate, sodium dehydroacetate, and 1,2-dibenzothiazolin-3-one (Proxel GXL, Proxel XL-2, Proxel LV, Proxel AQ, Proxel BD20, and Proxel DL from Arch Chemicals, Inc.).

Specific examples of the viscosity adjusters include mainly water-soluble natural or synthetic polymers such as carboxymethyl cellulose, sodium polyacrylate, polyvinylpyrrolidone, gum arabic, and starch.

Specific examples of pH adjusters include collidine, imidazole, phosphoric acid, 3-(N-morpholino)propanesulfonic acid, tris(hydroxymethyl)aminomethane, and boric acid.

Specific examples of the chelating agents include ethylenediaminetetraacetic acid, ethylenediaminediacetic acid, nitrilotriacetic acid, 1,3-propanediaminetetraacetic acid, diethylenetriaminepentaacetic acid, N-hydroxyethyl ethylenediaminetriacetic acid, iminodiacetic acid, uramildiacetic acid, 1,2-diaminocyclohexane-N,N,N′,N′-tetraacetic acid, malonic acid, succinic acid, glutaric acid, maleic acid, and salts thereof (including hydrates).

Examples of the antioxidants or UV absorbers include allophanates such as allophanate and methyl allophanate, biurets such as biuret, dimethyl biuret, and tetramethyl biuret, L-ascorbic acid and salts thereof, Tinuvin 328, 900, 1130, 384, 292, 123, 144, 622, 770, and 292, Irgacor 252 and 153, Irganox 1010, 1076, and 1035, and MD1024 manufactured by Ciba-Geigy, and oxides of lanthanides.

### (Method for Producing Ink Jet Textile Printing Ink)

The ink jet textile printing ink of the present invention can be produced by producing an aqueous pigment dispersion containing a pigment at a high concentration and mixing the aqueous pigment dispersion with a polyether-based urethane resin as a binder resin, and other binder resins, aqueous media, surfactants, and additives as needed.

Examples of the method for producing the aqueous pigment dispersion include the following methods (1) to (3).
(1) A method for preparing the aqueous pigment dispersion by adding a pigment to a mixture containing a dispersion resin and water, and then dispersing the pigment in the mixture using a stirring and dispersing apparatus.
(2) A method for preparing the aqueous pigment dispersion by kneading a pigment and a dispersion resin using a kneader such as a two-roll or a mixer, adding water and, as needed, an organic solvent miscible with water to the obtained kneaded product, and using a stirring and dispersing apparatus.
(3) A method for preparing the aqueous pigment dispersion by adding a pigment to a solution obtained by dissolving a dispersion resin in an organic solvent having compatibility with water, such as methyl ethyl ketone or tetrahydrofuran, then dispersing the pigment in the organic solution using a stirring and dispersing apparatus, then performing phase inversion emulsification using an aqueous medium such as water, and then distilling off the organic solvent.

The kneader is not limited to a particular one, and examples thereof include Henschel mixers, pressure kneaders, Banbury mixers, intensive mixers, planetary mixers, and butterfly mixers.

Examples of the stirring and dispersing apparatus include ultrasonic homogenizers, high-pressure homogenizers, paint shakers, ball mills, roll mills, sand mills, sand grinders, dyno mills, Dispermat, SC mills, and Nanomizer, which can be used alone or two or more of which can be used in combination.

It is preferable to use the aqueous pigment dispersion containing the pigment in an amount of 5% by mass to 60% by mass of pigment with respect to the total amount of the aqueous pigment dispersion, and it is more preferable to use the aqueous pigment dispersion with the amount of 10% by mass to 50% by mass in order to obtain an ink capable of forming printed matter with high image density and having excellent dispersion stability.

Coarse particles contained in the aqueous pigment dispersion cause degradation of image characteristics, and thus it is preferable to use the aqueous pigment dispersion from which coarse particles are removed by centrifugal separation, filtration treatment, or the like before and after producing the ink.

In producing the aqueous pigment dispersion, after a dispersion step, an impurity removal step by ion exchange treatment or ultrafiltration treatment may be performed, and then posttreatment may be performed. The ion exchange treatment can remove ionic substances such as cations and anions (divalent metal ions and the like), and the ultrafiltration treatment can remove impurity dissolved substances (residual substances during pigment synthesis, excess components in the dispersion liquid composition, resins not adsorbed on the organic pigment, mixed foreign substances, and the like). For the ion exchange treatment, known ion exchange resins are used. For the ultrafiltration treatment, known ultrafiltration membranes are used, which may be either a normal type or a doubled capacity type.

Examples of the method of mixing the aqueous pigment dispersion obtained by the above method with the polyether-based urethane resin and the like include a method of producing a mixture of an aqueous dispersion of the polyether-based urethane resin and the like in advance and mixing the mixture with the aqueous pigment dispersion, and a method of mixing the aqueous pigment dispersion and an aqueous dispersion of the polyether-based urethane resin, and then further adding other additives such as a surfactant.

As the ink jet textile printing ink of the present invention obtained by the above method, the mass ratio of the pigment with respect to the total amount of the ink (pigment concentration) is preferably 1% by mass to 20% by mass in order to ensure the necessity of obtaining sufficient image density and good dispersion stability of the pigment in the ink.

The pH of the ink is preferably 7.0 or more, more preferably 7.5 or more, and even more preferably 8.0 or more in order to improve the storage stability and ejection stability of the ink, and to improve wetting and spreading, print density, and water-resistant fastness when printed on fabrics that are easy to absorb or difficult to absorb ink. The upper limit of pH of the ink is preferably 11.0 or less, more preferably 10.0 or less, and even more preferably 9.5 or less in order to inhibit deterioration of members (for example, an ink ejection port, an ink flow path, and the like) constituting an ink applying or ejecting apparatus and to reduce the influence of the ink adhering to skin.

The ink jet textile printing ink of the present invention can be used, for example, in a printing method with an ink circulation type ink jet head.

Examples of a printing apparatus including the ink circulation type ink jet head include a printing apparatus having an ink inflow path and an ink outflow path separately from an ink ejection nozzle, and including a head having an ink circulation structure such that ink discharged from the outflow path is supplied to the ink jet head again via the inflow path. In addition, as the printing apparatus, one provided with a filter in the middle of the circulation structure can be suitably used.

It is preferable to use the filter with a pore diameter in a range of 5 μm to 20 μm, and in order to produce the effect of removing foreign matter that may be generated in the vicinity of the nozzle, it is preferable to use one with a pore diameter in a range of 5 μm to 10 μm.

The ink tank for supplying the ink is not limited to a particular ink tank, but plastic bottles may be used or pouch type ink bags may be used. Ink tanks or ink bags provided with circulation functions may also be used.

Examples of a recording medium that can be used when printed matter is produced using the ink jet textile printing ink of the present invention, the printing method, and the printing apparatus include fabrics and film base materials.

### (Printing on Fabric)

The fabric generally means a woven fabric made by alternately weaving yarns made of fiber such as cotton in a longitudinal direction and a transverse direction. The ink jet textile printing ink of the present invention is suitable not only for fabrics in the general sense, but also for media including fibers, such as non-woven fabrics and knitted fabrics. As the material, fabrics made of any natural fibers or synthetic fibers such as cotton, silk, wool, hemp, nylon, polyester, polyurethane, and rayon, or fabrics blended with these fibers can be used.

Examples of the method of printing on the fabric include a method of printing the ink jet textile printing ink of the present invention on the fabric using, for example, a printing apparatus including an ink circulation type ink jet head.

In this case, the shortest distance between the ink ejection port of the ink circulation type ink jet head and the fabric is preferably set to 1 mm or more. The shortest distance is more preferably set to 2 mm or more, and can be set to 3 mm or more in order to prevent contact between the surface of the fabric (a recording surface) and the ink ejection port, and to effectively prevent damage to the ink ejection port or faulty ink ejection caused by the deterioration of a water repellent function, which the ink ejection port often includes, even if the fabric has large fluffiness or unevenness. Even when the distance between the surface of the fabric and the ink jet head is long, the upper limit of the distance is preferably 10 mm or less, and more preferably 5 mm or less in order to produce printed matter without any streaks.

The shortest distance may be the distance (gap) from a surface (x) having the ink ejection port of the ink jet head to a position (y) where the perpendicular line of the surface (x) (an assumed perpendicular line to the surface (x)) intersects the fabric.

The lower limit of the size of ink droplets when ejected from the ink circulation type ink jet head in the shortest distance is preferably 10 pl, more preferably 15 pl, and even more preferably 20 pl, and the upper limit is preferably 50 pl, more preferably 45 pl, and even more preferably 40 pl in order to produce printed matter with excellent image quality free from streaks or the like, and to obtain printed matter with even better washing resistance.

### (Transfer Printing)

Printed matter obtained by printing the ink of the present invention on a film base material is called a transfer film, and printed matter printed on a fabric can be obtained by overlapping a transferred surface of the fabric and a printed surface of the transfer film, and then performing thermal transfer. That is, the method for producing printed matter of the present invention includes a step of printing the ink jet textile printing ink of the present invention on a film base material to obtain a transfer film, and a step of overlapping a transferred surface of a fabric and a printed surface of the transfer film, and performing thermal transfer.

### (Film Base Material)

As the film base material, known film base materials for transfer used in transfer printing methods for fabrics may be used. The film base material may be a single-layer structure consisting only of a base film, or may be a multilayer film with other layers formed on the base film. The film base material is preferably a multilayer film having a base film and a release layer.

Examples of base film include resin films such as polyolefin-based films such as a polypropylene film, a polyethylene film, and a polypropylene film; polyester-based films such as a polyethylene terephthalate film, a polybutylene terephthalate film, and a polyethylene naphthalate film; cellulose-based films such as a diacetyl cellulose film and a triacetyl cellulose film; polyurethane-based films; polyamide-based films; polyimide-based films; polyacrylate-based films; polymethacrylate-based films; and polycarbonate-based films. The polyolefin-based film and the polyurethane-based film are preferred because the films follow the unevenness of the fiber mesh of the fabric to obtain high fixability. On the other hand, from the viewpoint of excellent transfer quality and high color development, the polyester-based film is preferred, and the polyethylene terephthalate film is more preferred. Therefore, the film base material preferably includes the polyester-based film, the polyolefin-based film, or the polyurethane-based film.

The release layer may be the same as the release layer of known multilayer transfer films. The release layer may be a silicone layer or non-silicone layer, which is not limited to a particular one. Examples of the method for constructing the release layer on the base film include coating and laminating, which is not limiting.

When the film base material has a multilayer structure, it may have layers other than the base film and the release layer. Examples thereof include an antistatic treatment layer.

The film base material is preferably preheated before printing.

The transfer film can be obtained by ejecting the ink jet textile printing ink onto the film base material by an ink jet method using an ink jet recording apparatus. As the ink jet recording apparatus, known ink jet recording apparatuses may be used, and examples thereof include ink jet recording apparatuses including an ink jet head of a continuous injection type (a charge-controlled type, a spray type, or the like), an on-demand type (a piezo type, a thermal type, an electrostatic suction type, or the like), or the like. The use of an ink jet recording apparatus including an ink circulation type ink jet head is preferred in order to exhibit the effect of the present invention.

In this case, the shortest distance between the ink ejection port of the ink circulation type ink jet head and the film base material is preferably set to 0.5 mm or more. Since, unlike the fabric, the film base material has less fluff and unevenness, the shortest distance is more important for the production of printed matter with no streaks rather than for preventing contact between the recording surface and the ink ejection port, and for effectively preventing damage to the ink ejection port or faulty ink ejection caused by the deterioration of a water repellent function, which the ink ejection port often includes. Therefore, the upper limit of the distance is preferably 5 mm or less, and more preferably 3 mm or less. The lower limit of the distance is not limited to a particular distance, but it is more preferably 0.8 mm or more, and even more preferably 1 mm or more.

The ink jet textile printing ink may be dried on the film base material. For example, this can be done by heating the ejected ink jet textile printing ink using a heating device such as a heater, a hot plate, an oven, a hot air dryer, or a near-infrared light. Note that if the water-soluble solvent or the like contained in ink jet textile printing ink remains in the printed layer, the remaining solvent may volatilize to lower the transfer quality when the transfer film is heated for transfer to a transferred object. Therefore, the drying temperature is preferably 80° C. or higher and 160° C. or lower, and more preferably 100° C. or higher and 150° C. or lower. The drying time may be set as appropriate in accordance with the drying temperature, which is, for example, 1 minute or more and 10 minutes or less.

### (Thermal Transfer)

The ink of the present invention is ink jet-printed on the film base material to make the transfer film, and through a step of overlapping the transferred surface of the fabric and the printed surface of the resulting transfer film, and performing thermal transfer (may be referred to as a thermal transfer step), the printed matter of the present invention can be obtained.

The transferred surface of the fabric may be subjected to a pretreatment step to improve transferability and fixability as needed. The pretreatment step may be, for example, a step of applying water or a pretreatment agent by spraying, a coater, ink jetting, or the like.

The thermal transfer means applying pressure while heating, and can be performed by known thermal transfer methods. As a thermal transfer apparatus, a heat press apparatus or the like can be used.

The heating temperature is not limited to a particular temperature so long as the printed layer can be transferred, which is, for example, 125° C. or higher, and preferably 130° C. or higher. On the other hand, the heating temperature is below the melting point of the film base material of the transfer film, which is, for example, 200° C. or lower, and preferably 185° C. or lower. When the heating temperature is the softening point of the film base material of the transfer film or higher, it is advantageous because the film base material can be made to follow the unevenness of the fiber mesh of the fabric, thereby improving the fixability of the printed layer to be transferred to the fabric. The pressure is not limited to a particular pressure so long as the printed layer can be transferred, which is, for example, 100 g/cm² or more and 10,000 g/cm² or less, and preferably 200 g/cm² or more and 5,000 g/cm² or less. The pressurization time is not limited to a particular time so long as the printed layer can be transferred, which is, for example, 3 seconds or more and 5 minutes or less, and preferably 5 seconds or more and 1 minute or less.

### (Step of Applying Adhesive Resin)

The method for producing printed matter of the present invention may include a step of applying an adhesive resin to the printed surface of the transfer film prior to the thermal transfer step, which is preferred.

By this step, the adhesive resin is applied only to a printed part of the transfer film, and then the adhesive resin is melted by thermal transfer to bond the fabric and the printed surface to each other, making the fixability of the printed surface stronger.

### (Adhesive Resin)

The adhesive resin is not limited to a particular adhesive resin, known adhesive resins can be used, and examples thereof include ones containing mainly polyester polyurethane. It may also contain additives such as waxes.

Various commercially available products sold under the names of hot melt powder, hot melt binder, heat powder, transfer powder, DTF heat powder, DTF powder, and the like can also be used. Not only a white adhesive resin, but also a black colored adhesive resin can be used.

The adhesive resin may be liquid or powder, but it is preferably powder (in powder form). When the adhesive resin is powder, even if the ink jet textile printing ink is not sufficiently dried on the film base material, the adhesive resin adheres only to the printed surface by applying the adhesive resin, allowing only a necessary amount of the adhesive resin to be used, and reducing energy and steps to dry the ink jet textile printing ink.

The method for applying the adhesive resin is not limited to a particular method, and known application methods can be used. For small-volume printing on single sheets, the adhesive resin powder may be sprinkled manually on each piece of printed matter. When mass printing by what is called roll-to-roll is performed, a commercially available DTF shaker (an adhesive resin application apparatus) is also preferably used.

The method for producing printed matter of the present invention may include other steps. Examples of the other steps include a pretreatment step, a posttreatment step, and a drying step, which are not limiting.

### (Indentation Depth)

The ink jet textile printing ink of the present invention has a difference between an indentation depth at 100° C. and an indentation depth at 30° C. of a 15 μm thick coating film of the ink applied onto a polyethylene terephthalate plate and dried of less than 250 nm.

The indentation depth refers to a value obtained by measuring a depth at which a test indenter is indented when a constant load is applied using an ultramicro indentation hardness tester ENT-5 (manufactured by Elionix, Inc.). Specifically, it refers to an indentation depth (unit: nm) measured under the following conditions. As the indentation depth is deeper, the coating film is softer.

### Measurement Apparatus: Ultramicro Indentation Hardness Tester ENT-5 (Manufactured by Elionix Inc.)

Sample: It is produced by applying the ink jet textile printing ink onto a polyethylene terephthalate plate by spin coating so as to give a film thickness of 15 μm, and drying it in an oven at 130° C. for 15 minutes. After the temperature is adjusted to 30° C. and 100° C., measurement is performed.

The ink jet textile printing ink of the present invention has a value of a difference H−L in indentation depth of less than 250 nm when the indentation depth at 30° C. is L (nm), and the indentation depth at 100° C. is H (nm).

The value of the difference H−L in indentation depth being less than 250 nm means that there is no significant difference between the indentation depth at 100° C. and the indentation depth at 30° C. When such an ink is heated by thermal transfer or the like, even if the fibers of the fabric float or pop out, the ink film does not become softer than the fibers of the fabric during heating, and the ink film is not broken by the fibers or the ink film does not become locally thin. Therefore, even if the coating film on the fabric is stretched, the coating film is less likely to crack.

The ink of the present invention has a value of the difference H−L in indentation depth of less than 250 nm, which is preferably less than 200 nm, more preferably less than 180 nm, and even more preferably less than 100 nm. When the value of the difference H−L in indentation depth is within this range, the ink coating film on the fabric is less likely to crack due to stretching, the thickness of the coating film is uniform, and the color density (whiteness for the white ink) is also improved.

### <Textile Printed Matter>

The textile printed matter of the present invention is printed matter in which the ink of the present invention is printed on a fabric, and specifically, textile printed matter in which an ink jet textile printing ink containing a pigment and a binder resin is printed on a fabric, in which the binder resin is a polyether-based urethane resin, and the ink has a difference between an indentation depth at 100° C. and an indentation depth at 30° C. of a 15 μm thick coating film of the ink applied onto a polyethylene terephthalate plate and dried of less than 250 nm.

The textile printed matter is suitably used as especially textile printed matter such as T-shirts because the ink follows the fabric even when the fabric is stretched, and is less likely to crack. It can also be used for other textile printed matter, such as clothing, leather, ornaments, scarves, wrapping cloths, saris, curtains, bedding, tablecloths, embroidery thread, stuffed animals, novelty goods, flags, and banners, and especially textile printed matter printed on an easily stretchable base material is preferred in order to produce the effect of the present invention.

### EXAMPLES

The present invention will be described in detail below with examples, but the present invention is not limited only to these examples.

### (Preparation of Binder Resin)

### <Production of Binder Resin 1>

In a nitrogen-substituted vessel including a thermometer, a nitrogen gas introducing tube, and a stirrer, 1,000 parts by mass of polytetramethylene ether glycol (number average molecular weight: 3,000), 314 parts by mass of dicyclohexylmethane diisocyanate, and 0.1 part by mass of tin(II) octylate were added, the mixture was reacted at 100° C. for 1 hour, then 597 parts by mass of methyl ethyl ketone were added, 67 parts by mass of 2,2-dimethylolpropionic acid and 13 parts by mass of 2,2-dimethyl-1,3-propanediol were added, the mixture was reacted at 80° C. for 3 hours, and then 332 parts by mass of methyl ethyl ketone were added to obtain a methyl ethyl ketone solution of a urethane prepolymer having an isocyanate group at the molecular end. To the methyl ethyl ketone solution of the urethane prepolymer obtained above, 55 parts by mass of triethylamine were added to neutralize carboxy groups in the urethane prepolymer, and then 3,664 parts by mass of water were added. Next, 13 parts by mass of an 80% by mass aqueous hydrazine solution were added and reacted. After the end of the reaction, methyl ethyl ketone was removed under reduced pressure at a temperature of 40° C. to 60° C., and water was added to perform concentration adjustment to obtain a binder resin 1, which contains a polyether-based urethane resin with a nonvolatile content of 35% by mass, a weight average molecular weight of 270,000, an acid value of 20 mgKOH/g, and a glass transition temperature of −82° C., in which the urethane resin was dispersed in an aqueous medium. The flow starting temperature of the binder resin 1 was 183° C.

### <Production of Binder Resin 2>

In a nitrogen-substituted vessel including a thermometer, nitrogen gas introducing tube, and a stirrer, 1,000 parts by mass of poly tetramethylene ether glycol (number average molecular weight: 2,000) and 412 parts by mass of methyl ethyl ketone were added, the mixture was stirred uniformly, then 141 parts by mass of dicyclohexylmethane diisocyanate and 0.1 part by mass of tin(II) octylate were added, and the mixture was reacted at 70° C. for about 3 hours. Next, 141 parts by mass of dicyclohexylmethane diisocyanate were added, the mixture was stirred uniformly, then 100 parts by mass of polyethylene glycol (number average molecular weight: 1,000), 100 parts by mass of polytetramethylene ether glycol (number average molecular weight: 1,000), 44 parts by mass of 2,2-dimethylolpropionic acid, 294 parts by mass of methyl ethyl ketone, and 0.1 part by mass of tin(II) octylate were added, and the mixture was reacted at 70° C. for about 4 hours to obtain a methyl ethyl ketone solution of a urethane prepolymer having an isocyanate group at the molecular end. Next, after being diluted with 392 parts by weight of methyl ethyl ketone, 35 parts by mass of triethylamine were added to the methyl ethyl ketone solution of the urethane prepolymer obtained by the above method to neutralize the carboxy groups in the urethane prepolymer, then 4,481 parts by mass of ion exchanged water were added, and then 87 parts by mass of isophoronediamine were added and reacted. After the end of the reaction, methyl ethyl ketone was removed under reduced pressure at a temperature of 40° C. to 60° C., and water was added to perform concentration adjustment to obtain a binder resin 2, which contains a polyether-based urethane resin with a nonvolatile content of 35% by mass, a weight average molecular weight of 50,000, an acid value of 11 mgKOH/g, and a glass transition temperature of −77° C., in which the urethane resin was dispersed in an aqueous medium. The flow starting temperature of the binder resin 2 was 185° C.

### <Binder Resin 3>

As a binder resin 3, Neorez R-967 (manufactured by DSM), a polyether-based urethane resin, was used.

### <Production of Binder Resin 4>

In a nitrogen-substituted vessel including a thermometer, nitrogen gas introducing tube, and a stirrer, 500 parts by mass of a polycarbonate polyol (number average molecular weight: 2,000) obtained by reacting 1,6-hexanediol with methyl carbonate, 500 parts by mass of polytetramethylene ether glycol (number average molecular weight: 2,000), 90 parts by mass of 2,2-dimethylolpropionic acid, and 643 parts by mass of methyl ethyl ketone were added, 411 parts by mass of dicyclohexylmethane diisocyanate and 0.1 part by mass of tin(II) octylate were added, and the mixture was reacted at 80° C. for 3 hours to obtain a methyl ethyl ketone solution of a urethane prepolymer having an isocyanate group at the molecular end. Next, after being diluted with 584 parts by mass of methyl ethyl ketone, 81 parts by mass of triethylamine were added to the methyl ethyl ketone solution of the urethane prepolymer obtained above to neutralize carboxy groups in the urethane prepolymer, and then 3,831 parts by mass of water were added. Next, 22 parts by mass of an 80% by mass aqueous hydrazine solution were added and reacted. After the end of the reaction, methyl ethyl ketone was removed under reduced pressure at a temperature of 40° C. to 60° C., and water was added to perform concentration adjustment to obtain a binder resin 4, which contains a polycarbonate polyether-based urethane resin with a nonvolatile content of 35% by mass, a weight average molecular weight of 334,000, an acid value of 25 mgKOH/g, and a glass transition temperature of −23° C., in which the urethane resin was dispersed in an aqueous medium. The flow starting temperature of the binder resin 4 was 147° C.

### <Production of Binder Resin 5>

In a nitrogen-substituted vessel including a thermometer, a nitrogen gas introducing tube, and a stirrer, 1,000 parts by mass of a polycarbonate polyol (number average molecular weight 2,000) obtained by reacting 1,6-hexanediol with methyl carbonate, 50 parts by mass of dimethylolpropionic acid, and 730 parts by mass of methyl ethyl ketone were added, which were uniformly mixed, then 306 parts by mass of dicyclohexylmethane diisocyanate were added, then 0.1 part by mass of tin(II) octylate was added, and the mixture was reacted at 70° C. for about 4 hours to obtain a methyl ethyl ketone solution of a urethane prepolymer having an isocyanate group at the molecular end. Next, 39 parts by mass of triethylamine were added to the methyl ethyl ketone solution of the urethane prepolymer obtained by the above method to neutralize carboxy groups in the urethane prepolymer, then 3,993 parts by mass of ion exchanged water were added, and then 45 parts by mass of isophoronediamine were added and reacted. After the end of the reaction, methyl ethyl ketone was removed under reduced pressure at a temperature of 40° C. to 60° C., and water was added to perform concentration adjustment to obtain a binder resin 5, which contains a polycarbonate-based urethane resin with a nonvolatile content of 35% by mass, a weight average molecular weight of 330,000, an acid value of 15 mgKOH/g, and a glass transition temperature of −20° C., in which the urethane resin was dispersed in an aqueous medium. The flow starting temperature of the binder resin 5 was 152° C.

### <Production of Binder Resin 6>

In a nitrogen-substituted vessel including a thermometer, a nitrogen gas introducing tube, and a stirrer, 1,000 parts by mass of a polycarbonate polyol (number average molecular weight 2,000) obtained by reacting 1,6-hexanediol with methyl carbonate, 78 parts by mass of 2,2-dimethylolpropionic acid, and 600 parts by mass of methyl ethyl ketone were added, then 0.1 part by mass of tin(II) octylate was added, and the mixture was reacted at 80° C. for about 3 hours to obtain a methyl ethyl ketone solution of a urethane prepolymer having an isocyanate group at the molecular end. To the methyl ethyl ketone solution of the urethane prepolymer obtained above, 62 parts by mass of triethylamine were added to neutralize carboxy groups in the urethane prepolymer, and then 3,332 parts by mass of water were added. Next, 21 parts by mass of an 80% by mass aqueous hydrazine solution were added and reacted. After the end of the reaction, methyl ethyl ketone was removed under reduced pressure at a temperature of 40° C. to 60° C., and water was added to perform concentration adjustment to obtain a binder resin 6, which contains a polycarbonate-based urethane resin with a nonvolatile content of 35% by mass, a weight average molecular weight of 75,000, an acid value of 23 mgKOH/g, and a glass transition temperature of −37° C., in which the urethane resin was dispersed in an aqueous medium. The flow starting temperature of the binder resin 6 was 100° C.

### <Production of Binder Resin 7>

In a nitrogen-substituted vessel including a thermometer, a nitrogen gas introducing tube, and a stirrer, 1,000 parts by mass of a polycarbonate polyol (number average molecular weight 2,000) obtained by reacting 1,6-hexanediol with methyl carbonate, 94 parts by mass of 2,2-dimethylolpropionic acid, and 650 parts by mass of methyl ethyl ketone were added, then 0.1 part by mass of tin(II) octylate was added, and the mixture was reacted at 80° C. for about 3 hours to obtain a methyl ethyl ketone solution of a urethane prepolymer having an isocyanate group at the molecular end. To the methyl ethyl ketone solution of the urethane prepolymer obtained above, 74 parts by mass of triethylamine were added to neutralize carboxy groups in the urethane prepolymer, and then 3,610 parts by mass of water were added. Next, 23 parts by mass of an 80% by mass aqueous hydrazine solution were added and reacted. After the end of the reaction, methyl ethyl ketone was removed under reduced pressure at a temperature of 40° C. to 60° C., and water was added to perform concentration adjustment to obtain a binder resin 7, which contains a polycarbonate-based urethane resin with a nonvolatile content of 35% by mass, a weight average molecular weight of 202,000, an acid value of 26 mgKOH/g, and a glass transition temperature of −27° C., in which the urethane resin was dispersed in an aqueous medium. The flow starting temperature of the binder resin 7 was 164° C.

### <Binder Resin 8>

As a binder resin 8, Hydran HW-311 (manufactured by DIC Corporation), an aromatic polyester-based urethane resin, was used. The glass transition temperature of the binder resin 8 was −31° C. and the flow starting temperature was 95° C.

### <Binder Resin 9>

As a binder resin 9, Neorez R-600 (manufactured by DSM), a polyether-based urethane resin, was used.

### <Binder Resin 10>

As a binder resin 10, M-141 (manufactured by Seiko PMC Corporation), an acrylic resin, was used.

### (Production Example 1: Production of Aqueous Pigment Dispersion (A1))

Mixed were 45 parts by mass of Ti-Pure TS-6300 (manufactured by Chemours) as a pigment, 4.5 parts by mass of Solsperse 43000 Aqueous Dispersant (manufactured by Lubrizol) as a dispersion resin, and 50.5 parts by mass of ion exchanged water, and the mixture was circulated through a 0.6 L nano mill with (=0.5 mm zirconia beads introduced with a filling rate of 90% at a rotor peripheral speed of 12.5 m/s and a flow rate of 10 g/s for 30 minutes with stirring.

Next, the dispersion was collected, diluted with ion exchanged water to a pigment concentration of 40%, and mixed to obtain an aqueous pigment dispersion (A1).

### Production Example 2: Synthesis of Polymer E

A hexane solution of BuLi and a styrene solution in which styrene had been previously dissolved in tetrahydrofuran were introduced from the tube reactors P1 and P2 illustrated in FIG. 1 to the T-shaped micromixer M1, in which they were subjected to living anionic polymerization to obtain a polymer.

Next, the polymer obtained in the above step was transferred to the T-shaped micromixer M2 through a tube reactor R1 illustrated in FIG. 1, and the growing end of the polymer was trapped with a reaction adjuster (α-methylstyrene (α-MeSt)) introduced from the tube reactor P3.

Next, a tert-butyl methacrylate solution in which tert-butyl methacrylate had been previously dissolved in tetrahydrofuran was introduced to the T-shaped micromixer M3 from the tube reactor P4 illustrated in FIG. 1, which was subjected to a continuous living anionic polymerization reaction with the trapped polymer transferred through a tube reactor R2. Subsequently, methanol was supplied to quench the living anionic polymerization reaction and to obtain a block copolymer (PA-1) composition.

During the production of the block copolymer (PA-1) composition, the entire microreactor illustrated in FIG. 1 was buried in a thermostatic bath to set a reaction temperature at 24° C.

The molar ratio of the monomers constituting the block copolymer (PA-1) obtained by the above method was (BuLi/styrene/α-methylstyrene/tert-butyl methacrylate)=1.0/12.0/1.3/8.1.

The resulting block copolymer (PA-1) composition was hydrolyzed by treatment with a cation exchange resin, then distilled off under reduced pressure, and the resulting solid was pulverized to obtain a polymer E, a powdered dispersion aid with a weight average molecular weight of 2,710 and an acid value of 145. The powdered polymer (E) was neutralized 100% with KOH, and used as an aqueous solution with a resin solid content of 15%.

The various physical property values of the obtained polymer E, a dispersion aid, and the respective produced binder resins were measured as follows.

### (Method for Measuring Weight Average Molecular Weight (Mw))

Measurement was performed under the following conditions by a gel permeation chromatography (GPC) method.

Analysis apparatus: High-speed GPC apparatus (“HLC-8220GPC” manufactured by Tosoh Corporation)

Columns: The following columns manufactured by Tosoh Corporation, connected in series, were used.

$$“ TSKgel G 5000 ” ( 7.8 mm I . D . \times 30 cm ) \times 1$$

$$“ TSKgel G 4000 ” ( 7.8 mm I . D . \times 30 cm ) \times 1$$

$$“ TSKgel G 3000 ” ( 7.8 mm I . D . \times 30 cm ) \times 1$$

$$“ TSKgel G 2000 ” ( 7.8 mm I . D . \times 30 cm ) \times 1$$

Detector: RI (differential refractometer)
Column temperature: 40° C.
Elution solvent: Tetrahydrofuran (THF)
Flow rate: 1.0 mL/minute
Injection amount: 100 μL (a THF solution with a sample concentration of 0.4% by mass)
Standard samples: The following standard polystyrenes were used to prepare a calibration curve.

### (Standard Polystyrenes)

“TSKgel Standard Polystyrene A-500” manufactured by Tosoh Corporation
“TSKgel Standard Polystyrene A-1000” manufactured by Tosoh Corporation
“TSKgel Standard Polystyrene A-2500” manufactured by Tosoh Corporation
“TSKgel Standard Polystyrene A-5000” manufactured by Tosoh Corporation
“TSKgel Standard Polystyrene F-1” manufactured by Tosoh Corporation
“TSKgel Standard Polystyrene F-2” manufactured by Tosoh Corporation
“TSKgel Standard Polystyrene F-4” manufactured by Tosoh Corporation
“TSKgel Standard Polystyrene F-10” manufactured by Tosoh Corporation
“TSKgel Standard Polystyrene F-20” manufactured by Tosoh Corporation
“TSKgel Standard Polystyrene F-40” manufactured by Tosoh Corporation
“TSKgel Standard Polystyrene F-80” manufactured by Tosoh Corporation
“TSKgel Standard Polystyrene F-128” manufactured by Tosoh Corporation
“TSKgel Standard Polystyrene F-288” manufactured by Tosoh Corporation
“TSKgel Standard Polystyrene F-550” manufactured by Tosoh Corporation

### (Method for Measuring Acid Value)

The acid value was measured in conformity with JIS test method K 0070-1992. To determine the acid value, 0.5 g of a sample was dissolved in THF and titrated with a 0.1 M potassium hydroxide alcohol solution using phenolphthalein as an indicator.

### (Method for Measuring Flow Starting Temperature)

Each obtained binder resin was applied to release paper (application thickness: 150 μm), and dried in a hot air dryer at 70° C. for 2 minutes, and then at 120° C. for 2 minutes to obtain a dried product. The flow starting temperature of this dried product was measured using a flow tester manufactured by Shimadzu Corporation “CFT-500A” (using a die 1 MM in diameter and 1 MM in length, load: 98 N, temperature rise rate: 3° C./min).

### (Method for Measuring Glass Transition Temperature)

The glass transition temperature was obtained for each binder resin after completely removing the dispersion medium by measurement conforming to JIS K 7121 using a differential scanning calorimeter (DSC).

### Example 1

Mixed were 35 parts by mass of the aqueous pigment dispersion (A1), 40.0 parts by mass of the binder resin 1 (nonvolatile content: 35% by mass), 0.4 part by mass of Surfynol 440 (manufactured by Evonik, an acetylene-based surfactant), 0.2 part by mass of Surfynol 104PG50 (manufactured by Evonik, an acetylene-based surfactant), 2 parts by mass of glycerin, 10 parts by mass of ethylene glycol, 0.05 part by mass of ACTICIDE B-20 (manufactured by Thor Japan Ltd.) as a preservative, 1.7 parts by mass of a 15% by mass aqueous solution of the polymer E (100% neutralized with KOH), and ion exchanged water as the remainder to obtain an aqueous ink of Example 1.

### Example 2

An aqueous ink of Example 2 was obtained in the same manner as in Example 1 except that the binder resin of the ink was changed to the binder resin listed in Table 1.

### Comparative Examples 1 to 8

Aqueous inks of Comparative Examples 1 to 8 were obtained in the same manner as in Example 1 except that the binder resins of the inks were changed to the binder resins listed in Tables 2 and 3.

### (Production of Ink Coating Film for Indentation Depth Measurement)

The aqueous inks of Examples 1 and 2 and Comparative Examples 1 to 8 were each spin coated on a polyester film substrate (Lumirror manufactured by Toray Industries, Inc.), and dried with warm air at 130° C. for 15 minutes to obtain a white ink coating film of about 15 μm.

### (Measurement of Indentation Depth)

For the ink coating film obtained by the above method, an indentation depth when a test indenter was indented to the coating film with an end load of 100 μN (number of load divisions: 500, load step interval: 20 ms, load time: 10,000 ms) at 100° C. or 30° C. using an ultramicro indentation hardness tester ENT-5 (manufactured by Elionix Inc.) was measured. With the maximum indentation depth at 100° C. being H (nm) and the maximum indentation depth at 30° C. being L (nm), the value of a difference H−L in indentation depth was calculated and evaluated in accordance with the following criteria. Tables 1 to 3 list the evaluation results.
◯: a difference H−L in indentation depth of less than 250 nm
Δ: a difference H−L in indentation depth of 250 nm or more and less than 500 nm
x: a difference H−L in indentation depth of 500 nm or more and less than 800 nm
xx: a difference H−L in indentation depth of 800 nm or more

### (Evaluation of Circulation Filtration Properties (Resistance to Clogging of Filter Provided in Middle of Ink Circulation Path))

Circulation filtration properties were evaluated by circulating 200 g of the aqueous inks obtained in Examples and Comparative Examples in a circulation apparatus having a circulation path including a SUS mesh filter with a pore diameter of 12 μm (manufactured by Manabe Kogyo Co., Ltd.). The flow rate of the aqueous ink immediately after the start of circulation was adjusted to 50 g/min.

The flow rate of the aqueous ink was measured every hour from the start of circulation, and the elapsed time when its flow rate became 25 g/min or less was recorded, and the circulation filtration properties were evaluated based on the following evaluation criteria:
◯: 120 hours or more from the start of circulation
x: less than 120 hours from the start of circulation

### (Production of Printed Matter)

The aqueous ink obtained in Examples was printed solidly on a film base material (Dtf transfer film—8.3×11.7 manufactured by Godora) by ink jetting ejection using a head manufactured by Seiko Epson Corporation such that the film thickness after transfer was 15 μm, and left to stand for 30 minutes to obtain a transfer film. Then, adhesive resin powder (hot melt powder for DTF manufactured by Europort Co., Ltd.) was adsorbed on the ink-applied surface, and subjected to warm air drying at 160° C. for 3 minutes to cause the adhesive resin powder to adhere thereto. Finally, the adhesive resin powder surface was heat pressed against black cotton knit at 140° C. for 5 seconds to obtain textile printed matter of Examples 1 and 2 and Comparative Examples 1 to 8.

### (Evaluation of Whiteness)

The ink density (OD value) of the textile printed matter obtained by the above method was measured using X-Rite (a spectral densitometer and colorimeter manufactured by X-Rite, Inc.) to evaluate ink density on the fabric. Tables 1 to 3 list the evaluation results.

$$○ : {L}^{*} \geq 92.$$

$$△ : 90. \leq {L}^{*} < 92.$$

$$⨯ : {L}^{*} < 90.$$

### (Evaluation of Elongation Cracking)

Both ends of an image part of the textile printed matter obtained by the above method were held and stretched 150% in 1 second. The number of times the ink coating film cracked when this was repeated was scored by visual determination. Tables 1 to 3 list the evaluation results.
5: The coating film does not crack, and whiteness is maintained even after the ink-printed part is stretched 10 times or more.
4: The coating film cracks when the ink-printed part is stretched 7 to 10 times.
3: The coating film cracks when the ink-printed part is stretched 4 to 6 times.
2: The coating film cracks when the ink-printed part is stretched 2 or 3 times.
1: The coating film cracks by stretching the ink-printed part only once.

TABLE 1

| | Example 1 | Example 2 |
|---|---|---|
| Aqueous pigment dispersion (A1) | 35 | 35 |
| Binder resin 1 (solid content) | 14 | |
| Binder resin 2 (solid content) | | 14 |
| Surfynol 440 | 0.4 | 0.4 |
| Surfynol 104PG50 | 0.2 | 0.2 |
| Glycerin | 2 | 2 |
| Ethylene glycol | 10 | 10 |
| ACTICIDE B-20 | 0.05 | 0.05 |
| Polymer E 15% aqueous solution | 1.7 | 1.7 |
| Ion exchanged water | Remainder | Remainder |
| Difference H − L in indentation | ◯ | ◯ |
| depth | | |
| H − L (nm) | 141 | 82 |
| Circulation filtration properties | ◯ | ◯ |
| Whiteness | ◯ | ◯ |
| Elongation cracking | 5 | 5 |

TABLE 2

| | Comp. | Comp. | Comp. | Comp. |
|---|---|---|---|---|
| | Ex. 1 | Ex. 2 | Ex. 3 | Ex. 4 |
| Aqueous pigment dispersion (A1) | 35 | 35 | 35 | 35 |
| Binder resin 3 (solid content) | 14 | | | |
| Binder resin 4 (solid content) | | 14 | | |
| Binder resin 5 (solid content) | | | 14 | |
| Binder resin 6 (solid content) | | | | 14 |
| Surfynol 440 | 0.4 | 0.4 | 0.4 | 0.4 |
| Surfynol 104PG50 | 0.2 | 0.2 | 0.2 | 0.2 |
| Glycerin | 2 | 2 | 2 | 2 |
| Ethylene glycol | 10 | 10 | 10 | 10 |
| ACTICIDE B-20 | 0.05 | 0.05 | 0.05 | 0.05 |
| Polymer E 15% aqueous solution | 1.7 | 1.7 | 1.7 | 1.7 |
| Ion exchanged water | Remainder | Remainder | Remainder | Remainder |
| Difference H − L in indentation depth | Δ | Δ | Δ | x |
| Circulation filtration properties | x | x | ∘ | x |
| Whiteness | ∘ | ∘ | ∘ | Δ |
| Elongation cracking | 4 | 4 | 4 | 3 |

TABLE 3

| | Comp. | Comp. | Comp. | Comp. |
|---|---|---|---|---|
| | Ex. 5 | Ex. 6 | Ex. 7 | Ex. 8 |
| Aqueous pigment dispersion (A1) | 35 | 35 | 35 | 35 |
| Binder resin 7 (solid content) | 14 | | | |
| Binder resin 8 (solid content) | | 14 | | |
| Binder resin 9 (solid content) | | | 14 | |
| Binder resin 10 (solid content) | | | | 14 |
| Surfynol 440 | 0.4 | 0.4 | 0.4 | 0.4 |
| Surfynol 104PG50 | 0.2 | 0.2 | 0.2 | 0.2 |
| Glycerin | 2 | 2 | 2 | 2 |
| Ethylene glycol | 10 | 10 | 10 | 10 |
| ACTICIDE B-20 | 0.05 | 0.05 | 0.05 | 0.05 |
| Polymer E 15% aqueous solution | 1.7 | 1.7 | 1.7 | 1.7 |
| Ion exchanged water | Remainder | Remainder | Remainder | Remainder |
| Difference H − L in indentation depth | x | xx | xx | xx |
| Circulation filtration properties | x | ∘ | ∘ | Not |
| | | | | implemented |
| Whiteness | ∘ | ∘ | Δ | ∘ |
| Elongation cracking | 3 | 1 | 1 | 1 |

Note that the product names and the manufacturing company names in Tables 1 to 3 above are as follows. The contents of the binder resins in Tables 1 to 3 above are the values of solid contents.
Surfynol 440: an acetylene-based surfactant (manufactured by Evonik)
Surfynol 104PG50: an acetylene-based surfactant (manufactured by Evonik)
ACTICIDE B-20: a preservative (manufactured by Thor Japan Ltd.)

Examples 1 and 2, the inks of the present invention, had high whiteness in the printed matter, had no image cracking during stretching, and did not block the path even when the ink was circulated for a long period of time.

On the other hand, Comparative Examples 1 to 8, the difference in indentation depth of which was outside the range of the present invention, caused elongation cracking by the stretching of the fabric.

### REFERENCE SIGNS LIST

1 T-shaped micromixer M1
2 T-shaped micromixer M2
3 T-shaped micromixer M3
4 tube reactor R1
5 tube reactor R2
6 tube reactor R3
7 tube reactor P1 for pre-cooling
8 tube reactor P2 for pre-cooling
9 tube reactor P3 for pre-cooling
10 tube reactor P4 for pre-cooling

1. An ink jet textile printing ink comprising:
a pigment; and
a binder resin,
the binder resin containing a polyether-based urethane resin, and
a difference between an indentation depth at 100° C. and an indentation depth at 30° C. of a 15 μm thick coating film of the ink applied onto a polyethylene terephthalate plate and dried being less than 250 nm.

2. The ink jet textile printing ink according to claim 1, wherein the pigment is a white pigment.

3. The ink jet textile printing ink according to claim 2, wherein the white pigment is alumina-treated titanium oxide.

4. A method for producing printed matter, the method comprising:
a step of printing the ink jet textile printing ink according to claim 1 onto a film base material to obtain a transfer film; and
a step of overlapping a transferred surface of a fabric and a printed surface of the transfer film, and performing thermal transfer.

5. The method for producing printed matter according to claim 4, further comprising a step of applying an adhesive resin to the printed surface of the transfer film.

6. Textile printed matter in which an ink jet textile printing ink that comprises a pigment and a binder resin is printed on a fabric,
the binder resin being a polyether-based urethane resin, and
the ink being an ink having a difference between an indentation depth at 100° C. and an indentation depth at 30° C. of a 15 μm thick coating film of the ink applied onto a polyethylene terephthalate plate and dried of less than 250 nm.
